(19) United States
(12) Patent Application Publication
(10) Pub. No.: US 2026/0238947 A1
(43) Pub. Date: Aug. 13, 2026

(54) ACOUSTIC PROCESSING DEVICE, ACOUSTIC PROCESSING METHOD, AND RECORDING MEDIUM

(71) Applicant: Panasonic Intellectual Property Corporation of America, Torrance, CA (US)

(72) Inventors: Masahiro OSHIKIRI, Osaka (JP); Tomokazu Ishikawa, Osaka (JP); Hiroyuki Ehara, Kanagawa (JP); Hikaru Usami, Osaka (JP); Seigo Enomoto, Kyoto (JP); Kota Nakahashi, Osaka (JP)

(21) Appl. No.: 19/633,012

(22) Filed: Mar. 30, 2026

Related U.S. Application Data
(63) Continuation of application No. PCT/JP2024/035484, filed on Oct. 3, 2024.
(60) Provisional application No. 63/542,835, filed on Oct. 6, 2023.

(51) Int. Cl. H04S 7/00

(52) U.S. Cl. CPC H04S 7/302

(57) ABSTRACT

An acoustic processing device (information processing device) includes: an obtainer that obtains sound information including: an acoustic signal; and information on a state of a sound source object in a three-dimensional sound field; a relative relationship calculator that calculates a first relative relationship of the state between the sound source object and a user in the three-dimensional sound field at a predetermined time point, and a second relative relationship of the state between the sound source object and the user at a subsequent time point; and a reduction processor that generates an output sound signal excluding a signal of a sound, the output sound signal being generated by removing, according to the first relative relationship and the second relative relationship, the signal from among signals of a plurality of sounds generated for use in generating the output sound signal from the acoustic signal included in the sound information obtained.

### CROSS REFERENCE TO RELATED APPLICATIONS

This is a continuation application of PCT International Application No. PCT/JP2024/035484 filed on Oct. 3, 2024, designating the United States of America, which is based on and claims priority of U.S. Provisional Patent Application No. 63/542,835 filed on Oct. 6, 2023. The entire disclosures of the above-identified applications, including the specifications, drawings, and claims are incorporated herein by reference in their entirety.

### FIELD

The present disclosure relates to an acoustic processing device, an acoustic processing method, and a recording medium.

### BACKGROUND

Techniques for acoustic reproduction to make a user perceive three-dimensional sound in a virtual three-dimensional space are known (see, for example, Patent Literature (PTL) 1). In order to make the sound be perceived as arriving from a sound source object to the user in such a three-dimensional space, processing is required to generate output sound information from the original sound information. In particular, enormous processing is required to reproduce three-dimensional sound in response to the movement of the user's body in a virtual space. With the development of computer graphics (CG), it has become possible to construct visually complex virtual environments relatively easily, and technology for realizing corresponding auditory information has become important. In addition, when processing from sound information to output sound information is performed in advance, a large memory area for storing the pre-calculated processing results is required. When transmitting such large processing result data, a wide communication bandwidth may be required.

In order to achieve a sound environment that more closely resembles reality, the number of objects that produce sound in a virtual three-dimensional space increases, secondary sounds based on acoustic effects such as reflected sound, diffracted sound, and reverberation increase, and furthermore, these secondary sounds need to be appropriately changed in response to the movement of the user, requiring a large amount of processing.

### CITATION LIST

### Patent Literature

PTL 1: Japanese Unexamined Patent Application Publication No. 2020-18620

### SUMMARY

### Technical Problem

In view of this, the present disclosure has an object to provide an acoustic processing device and the like that can appropriately generate an output sound signal from the perspective of processing load.

### Solution to Problem

An acoustic processing device according to one aspect of the present disclosure includes: an obtainer that obtains sound information including: an acoustic signal; and information on a state of a sound source object in a three-dimensional sound field; a relative relationship calculator that calculates a first relative relationship that is a relative relationship of the state between the sound source object and a user in the three-dimensional sound field at a predetermined time point, and a second relative relationship that is a relative relationship of the state between the sound source object and the user in the three-dimensional sound field at a subsequent time point after the predetermined time point; and a reduction processor that generates an output sound signal excluding a signal of a sound, the output sound signal being generated by removing, according to the first relative relationship and the second relative relationship, the signal from among signals of a plurality of sounds generated for use in generating the output sound signal from the acoustic signal included in the sound information obtained.

An acoustic processing method according to one aspect of the present disclosure is an acoustic processing method executed by a computer, the acoustic processing method including: obtaining sound information including: an acoustic signal; and information on a state of a sound source object in a three-dimensional sound field; calculating a first relative relationship that is a relative relationship of the state between the sound source object and a user in the three-dimensional sound field at a predetermined time point, and a second relative relationship that is a relative relationship of the state between the sound source object object and the user in the three-dimensional sound field at a subsequent time point after the predetermined time point; and generating an output sound signal excluding a signal of a sound, the output sound signal being generated by removing, according to the first relative relationship and the second relative relationship, the signal from among signals of a plurality of sounds generated for use in generating the output sound signal from the acoustic signal included in the sound information obtained.

One aspect of the present disclosure may be realized as a non-transitory computer-readable recording medium for use in a computer, the recording medium having a computer program recorded thereon for causing the computer to execute the acoustic processing method described above.

Note that these general or specific aspects may be implemented using a system, a device, a method, an integrated circuit, a computer program, or a non-transitory computer-readable recording medium such as a CD-ROM, or any combination thereof.

### Advantageous Effects

The present disclosure makes it possible to appropriately generate an output sound signal.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating an example of use of an acoustic reproduction system according to an embodiment of the present disclosure.

FIG. 2 is a block diagram illustrating the functional configuration of an acoustic reproduction system according to an embodiment of the present disclosure.

FIG. 3 is a diagram for explaining one example of an audio signal according to an embodiment of the present disclosure.

FIG. 4 is a block diagram illustrating the functional configuration of an obtainer according to an embodiment of the present disclosure.

FIG. 5 is a block diagram illustrating the functional configuration of an output sound generator according to an embodiment of the present disclosure.

FIG. 6 is a diagram for explaining another example of an acoustic reproduction system according to an embodiment of the present disclosure.

FIG. 7 is a diagram for explaining another example of an acoustic reproduction system according to an embodiment of the present disclosure.

FIG. 8 is a diagram for explaining another example of an acoustic reproduction system according to an embodiment of the present disclosure.

FIG. 9 is a diagram for explaining another example of an acoustic reproduction system according to an embodiment of the present disclosure.

FIG. 10 is a diagram for explaining another example of an acoustic reproduction system according to an embodiment of the present disclosure.

FIG. 11 is a diagram for explaining another example of an acoustic reproduction system according to an embodiment of the present disclosure.

FIG. 12 is a diagram for explaining another example of an acoustic reproduction system according to an embodiment of the present disclosure.

FIG. 13 is a diagram for explaining another example of an acoustic reproduction system according to an embodiment of the present disclosure.

FIG. 14 is a diagram for explaining another example of an acoustic reproduction system according to an embodiment of the present disclosure.

FIG. 15 is a diagram for explaining a specific example of an acoustic reproduction system according to an example of an embodiment of the present disclosure.

FIG. 16 is a diagram for explaining a specific example of an acoustic reproduction system according to an example of an embodiment of the present disclosure.

FIG. 17 is a diagram for explaining a specific example of an acoustic reproduction system according to an example of an embodiment of the present disclosure.

FIG. 18 is a diagram for explaining a specific example of an acoustic reproduction system according to an example of an embodiment of the present disclosure.

FIG. 19 is a diagram for explaining a specific example of an acoustic reproduction system according to an example of an embodiment of the present disclosure.

FIG. 20 is a diagram for explaining a specific example of an acoustic reproduction system according to an example of an embodiment of the present disclosure.

FIG. 21 is a diagram for explaining a specific example of an acoustic reproduction system according to an example of an embodiment of the present disclosure.

FIG. 22 is a diagram for explaining a specific example of an acoustic reproduction system according to an example of an embodiment of the present disclosure.

FIG. 23 is a diagram for explaining a specific example of an acoustic reproduction system according to an example of an embodiment of the present disclosure.

FIG. 24 is a diagram for explaining a specific example of an acoustic reproduction system according to an example of an embodiment of the present disclosure.

FIG. 25 is a diagram for explaining a specific example of an acoustic reproduction system according to an example of an embodiment of the present disclosure.

FIG. 26 is a diagram for explaining a specific example of an acoustic reproduction system according to an example of an embodiment of the present disclosure.

FIG. 27 is a diagram for explaining a specific example of an acoustic reproduction system according to an example of an embodiment of the present disclosure.

FIG. 28 is a diagram for explaining a specific example of an acoustic reproduction system according to an example of an embodiment of the present disclosure.

FIG. 29 is a diagram for explaining a specific example of an acoustic reproduction system according to an example of an embodiment of the present disclosure.

FIG. 30 is a diagram for explaining a specific example of an acoustic reproduction system according to an example of an embodiment of the present disclosure.

FIG. 31 is a diagram for explaining a specific example of an acoustic reproduction system according to an example of an embodiment of the present disclosure.

FIG. 32 is a diagram for explaining a specific example of an acoustic reproduction system according to an example of an embodiment of the present disclosure.

FIG. 33 is a diagram for explaining a specific example of an acoustic reproduction system according to an example of an embodiment of the present disclosure.

### DESCRIPTION OF EMBODIMENT(S)

Underlying Knowledge Forming Basis of the Disclosure Techniques for acoustic reproduction to make a user perceive three-dimensional sound in a virtual three-dimensional space (hereinafter may be referred to as a three-dimensional sound field) are known (see, for example, PTL 1). By using this technique, the user can perceive the sound as if a sound source object is at a predetermined position in the virtual space and the sound is arriving from that direction. In order to localize a sound image at a predetermined position in a virtual three-dimensional space in this way, for example, computational processing is required to generate interaural time differences and interaural level differences (or sound pressure differences) between the ears for the signal of the sound that the sound source object is producing (also referred to as sound emitted from the sound source object, or reproduced sound), such that the sound is perceived as a three-dimensional sound. Such computational processing is performed by applying a three-dimensional sound filter. A three-dimensional sound filter is an information processing filter that, when applied to the original sound information and the resulting output sound signal is reproduced, allows the direction and distance of the sound, the size of the sound source, and the spaciousness to be perceived three-dimensionally.

As one example of computational processing for applying such a three-dimensional sound filter, processing that convolves a head-related transfer function for perceiving sound as arriving from a predetermined direction with the signal of the target sound is known. Performing the convolution processing of this head-related transfer function at sufficiently fine angles with respect to the direction of arrival of the reproduced sound from the position of the sound source object to the user's position enhances the sense of realism experienced by the user.

In recent years, development of technology related to virtual reality (VR) has been actively conducted. In virtual reality, the position of sound source objects in a virtual three-dimensional space appropriately changes in response to the user's movement, with the main focus being on allowing the user to physically experience as if they are moving within the virtual space. For this purpose, it is necessary to relatively move the localization position of the sound image in the virtual space in response to the user's movement. Such processing has been performed by applying a three-dimensional sound filter, such as the head-related transfer function mentioned above, to the original sound information. However, when a user moves in a three-dimensional space, the sound transmission path changes from moment to moment each time the positional relationship between the sound source object and the user changes, including sound reverberation and interference. As a result, it is necessary to determine the sound transmission path from the sound source object based on the positional relationship between the sound source object and the user each time, and to convolve the transfer function considering sound reverberation and interference. However, with such information processing, the processing amount becomes enormous, and without a large-scale processing device, it may not be possible to achieve an improvement in the sense of realism.

As a means to reduce such enormous processing amounts, attempts have been made to partially reduce the sounds to be reproduced. More specifically, for each of the many sound source objects in the three-dimensional space, or for each of the plurality of types of sounds generated from each of the sound source objects, rather than convolving the head-related transfer function with all of them, the sounds are partially reduced and then the head-related transfer function is convolved. By doing this, in the convolution of the head-related transfer function, which particularly requires a large processing amount, that is, in the process of generating a spatial audio signal for output (in other words, an output signal or an output sound signal), a significant reduction in the processing amount is expected because the number of sound signals to be processed is reduced.

However, indiscriminately reducing sound signals would lead to sound degradation, so in order to inhibit this sound degradation, it is necessary to reduce sounds with relatively little sound degradation. Here, assume that a sound suitable for reduction at a subsequent time point following a certain time point is reduced in advance at the certain time point. Although the sound to be reduced at the subsequent time point is also reduced at the preceding time point, the user is less likely to perceive the sound reduction as unnatural because the reduced sound is continuous. Stated differently, while maintaining a low sense of unnaturalness for the user, since sound reduction can be started from a slightly earlier time point, the number of sound signals to be reduced can be easily expanded, and the advantageous effect of a reduction in processing amount can be enhanced. This makes it possible to realize an acoustic processing device that can inhibit sound degradation while reducing the processing amount.

A more specific overview of the present disclosure is as follows.

An acoustic processing device according to a first aspect of the present disclosure includes: an obtainer that obtains sound information including: an acoustic signal; and information on a state of a sound source object in a three-dimensional sound field; a relative relationship calculator that calculates a first relative relationship that is a relative relationship of the state between the sound source object and a user in the three-dimensional sound field at a predetermined time point, and a second relative relationship that is a relative relationship of the state between the sound source object and the user in the three-dimensional sound field at a subsequent time point after the predetermined time point; and a reduction processor that generates an output sound signal excluding a signal of a sound, the output sound signal being generated by removing, according to the first relative relationship and the second relative relationship, the signal from among signals of a plurality of sounds generated for use in generating the output sound signal from the acoustic signal included in the sound information obtained.

That is, the acoustic processing device according to the first aspect predicts the relative relationship between the states of the listener and the object Δt later with respect to the relative relationship between the states of the listener (user) and the object (sound source object) at time t, and applies predetermined processing (reduction processing) to sounds reaching the listener in the state at time t and sounds reaching the listener in the state at time t+Δt.

According to such an acoustic processing device, by reducing in advance at a predetermined time point sounds suitable for reduction at a subsequent time point following the predetermined time point, since sound reduction can be started from a slightly earlier time point, the number of sound signals to be reduced can be easily expanded, and the advantageous effect of a reduction in processing amount can be enhanced while maintaining a low sense of unnaturalness for the user. Therefore, from the perspective of processing load, it is possible to appropriately generate an output sound signal.

An acoustic processing device according to a second aspect is the acoustic processing device according to the first aspect, wherein the state is a position in the three-dimensional sound field.

That is, the acoustic processing device according to the second aspect is an acoustic processing device in which the state is a spatial position.

According to such an acoustic processing device, a spatial position can be used as the state when calculating the first relative relationship and the second relative relationship.

An acoustic processing device according to a third aspect is the acoustic processing device according to the first aspect, wherein the state is an orientation in the three-dimensional sound field determined by at least one of an azimuth angle or an elevation angle.

That is, the acoustic processing device according to the third aspect is an acoustic processing device in which the state is an orientation determined by at least one of an azimuth angle or an elevation angle.

According to such an acoustic processing device, an orientation in the three-dimensional sound field determined by at least one of an azimuth angle or an elevation angle can be used as the state when calculating the first relative relationship and the second relative relationship.

An acoustic processing device according to a fourth aspect is the acoustic processing device according to the first aspect, wherein the state includes a position in the three-dimensional sound field and an orientation in the three-dimensional sound field determined by at least one of an azimuth angle or an elevation angle, and the first relative relationship and the second relative relationship when the state is the position in the three-dimensional sound field and the first relative relationship and the second relative relationship when the state is the orientation in the three-dimensional sound field have respectively different time intervals between the predetermined time point and the subsequent time point.

That is, the acoustic processing device according to the fourth aspect is an acoustic processing device in which the state is a position and an orientation, and the prediction of the position and the prediction of the orientation are performed at respectively different time resolutions.

According to such an acoustic processing device, a position in the three-dimensional sound field and an orientation in the three-dimensional sound field determined by at least one of an azimuth angle or an elevation angle can be used as the state when calculating the first relative relationship and the second relative relationship. In this case, the time interval between the predetermined time point and the subsequent time point when the state is the position in the three-dimensional sound field and the time interval between the predetermined time point and the subsequent time point when the state is the orientation in the three-dimensional sound field can be made respectively different.

An acoustic processing device according to a fifth aspect is the acoustic processing device according to the first aspect, wherein the state is at least one of a position in the three-dimensional sound field or an orientation in the three-dimensional sound field determined by at least one of an azimuth angle or an elevation angle, and the reduction processor removes the signal according to whether a temporal change in a relative relationship indicated by the second relative relationship with respect to the first relative relationship indicates movement in a direction in which the sound source object and the user move away from each other.

That is, the acoustic processing device according to the fifth aspect is an acoustic processing device in which the state is at least one of a spatial position or an orientation, and the relative relationship between the states is whether the listener and the object change in a direction in which they move away from each other.

According to such an acoustic processing device, at least one of a position in the three-dimensional sound field or an orientation in the three-dimensional sound field determined by at least one of an azimuth angle or an elevation angle can be used as the state when calculating the first relative relationship and the second relative relationship. Additionally, by making a determination using such a state, a signal of a sound can be removed according to whether movement in a direction in which the sound source object and the user move away from each other is indicated.

An acoustic processing device according to a sixth aspect is the acoustic processing device according to any one of the first to fifth aspects, wherein the reduction processor removes the signal from among the signals of the plurality of sounds according to the first relative relationship, the second relative relationship, and an importance level set for each sound with respect to the user.

That is, the acoustic processing device according to the sixth aspect is an acoustic processing device in which predetermined processing selects sounds that are less important to the listener.

According to such an acoustic processing device, a signal of a sound can be removed according to the first relative relationship, the second relative relationship, and an importance level set for each sound with respect to the user.

An acoustic processing device according to a seventh aspect is the acoustic processing device according to the sixth aspect, wherein the reduction processor removes the signal from among the signals of the plurality of sounds according to the first relative relationship, the second relative relationship, and an importance level set for each sound with respect to the user when a difference between the first relative relationship and the second relative relationship exceeds a predetermined threshold.

That is, the acoustic processing device according to the seventh aspect is an acoustic processing device in which predetermined processing performs processing according to the importance level of sounds reaching the listener when a sudden change is detected in the relative relationship of the state of the listener and the object after Δt.

According to such an acoustic processing device, a signal of a sound can be removed from among the signals of the plurality of sounds according to the first relative relationship, the second relative relationship, and an importance level set for each sound with respect to the user when a difference between the first relative relationship and the second relative relationship exceeds a predetermined threshold.

An acoustic processing device according to an eighth aspect is the acoustic processing device according to any one of the first to fifth aspects, wherein the reduction processor includes a culler that removes a signal of a sound by discarding the signal of the sound.

That is, the acoustic processing device according to the eighth aspect is an acoustic processing device in which predetermined processing culls sounds with a low importance level.

According to such an acoustic processing device, the sound signal can be removed by discarding the sound signal.

An acoustic processing device according to a ninth aspect is the acoustic processing device according to the eighth aspect, wherein the reduction processor includes an integrator that removes signals of at least two sounds by discarding the signals of the at least two sounds and supplementing one signal of a virtual sound that integrates the signals of the at least two sounds.

That is, the acoustic processing device according to the ninth aspect is an acoustic processing device in which predetermined processing outputs sounds represented by a number of virtual objects that is smaller than the number of sounds with a low importance level.

According to such an acoustic processing device, the signals of at least two sounds can be removed by discarding the signals of the at least two sounds and supplementing one signal of a virtual sound that integrates the signals of the at least two sounds.

An acoustic processing device according to a tenth aspect is the acoustic processing device according to the third aspect, wherein the reduction processor prohibits removal of a signal of a sound according to the second relative relationship when a change in the state of at least one of the sound source object or the user between the predetermined time point and the subsequent time point satisfies a predetermined condition.

That is, the acoustic processing device according to the tenth aspect is an acoustic processing device that stops predetermined processing on sounds reaching the listener in the state at time t+Δt when a change in the state of at least one of the listener or the object satisfies a predetermined condition.

According to such an acoustic processing device, removal of a signal of a sound according to the second relative relationship can be prohibited when a change in the state of at least one of the sound source object or the user between the predetermined time point and the subsequent time point satisfies a predetermined condition.

An acoustic processing device according to an eleventh aspect is the acoustic processing device according to the tenth aspect, wherein the predetermined condition is that the change in the state of at least one of the sound source object or the user between the predetermined time point and the subsequent time point is discontinuous.

That is, the acoustic processing device according to the eleventh aspect is an acoustic processing device in which the predetermined condition is that the change in the state is discontinuous.

According to such an acoustic processing device, removal of a signal of a sound according to the second relative relationship can be prohibited when a change in the state of at least one of the sound source object or the user between the predetermined time point and the subsequent time point is discontinuous.

An acoustic processing device according to a twelfth aspect is the acoustic processing device according to the tenth aspect or the eleventh aspect, wherein the predetermined condition is that a speed of the change in the state of at least one of the sound source object or the user between the predetermined time point and the subsequent time point exceeds a predetermined speed.

That is, the acoustic processing device according to the twelfth aspect is an acoustic processing device in which the predetermined condition is that the change in the state is faster than a predetermined speed.

According to such an acoustic processing device, removal of a signal of a sound according to the second relative relationship can be prohibited when a speed of the change in the state of at least one of the sound source object or the user between the predetermined time point and the subsequent time point exceeds a predetermined speed.

An acoustic processing device according to a thirteenth aspect is the acoustic processing device according to any one of the tenth to twelfth aspects, wherein the predetermined condition is that an occurrence of an obstacle between the sound source object and the user is indicated.

That is, the acoustic processing device according to the thirteenth aspect is an acoustic processing device in which the predetermined condition is that an obstacle is detected between the listener and the object.

According to such an acoustic processing device, removal of a signal of a sound according to the second relative relationship can be prohibited when an occurrence of an obstacle between the sound source object and the user is indicated.

An acoustic processing device according to a fourteenth aspect is the acoustic processing device according to any one of the tenth to thirteenth aspects, wherein the predetermined condition is that a deviation between a calculation result of the state of at least one of the sound source object or the user at the subsequent time point and an actual measurement value exceeds a predetermined threshold.

That is, the acoustic processing device according to the fourteenth aspect is an acoustic processing device in which the predetermined condition is that a difference between a predicted value of the state at time t+Δt and an actual state exceeds a predetermined threshold.

According to such an acoustic processing device, removal of a signal of a sound according to the second relative relationship can be prohibited when a deviation between a calculation result of the state of at least one of the sound source object or the user at the subsequent time point and an actual measurement value exceeds a predetermined threshold.

An acoustic processing method according to a fifteenth aspect is an acoustic processing method executed by a computer, the acoustic processing method including: obtaining sound information including: an acoustic signal; and information on a state of a sound source object in a three-dimensional sound field; calculating a first relative relationship that is a relative relationship of the state between the sound source object and a user in the three-dimensional sound field at a predetermined time point, and a second relative relationship that is a relative relationship of the state between the sound source object and the user in the three-dimensional sound field at a subsequent time point after the predetermined time point; and generating an output sound signal excluding a signal of a sound, the output sound signal being generated by removing, according to the first relative relationship and the second relative relationship, the signal from among signals of a plurality of sounds generated for use in generating the output sound signal from the acoustic signal included in the sound information obtained.

According to this, advantageous effects similar to those of the acoustic processing device described above can be achieved.

A recording medium according to a sixteenth aspect is a non-transitory computer-readable recording medium for use in a computer, the recording medium having a computer program recorded thereon for causing the computer to execute the acoustic processing method described above.

According to this, advantageous effects similar to those of the acoustic processing method described above can be achieved using a computer.

Furthermore, these general or specific aspects may be implemented using a system, a device, a method, an integrated circuit, a computer program, or a non-transitory computer-readable recording medium such as a CD-ROM, or any combination thereof.

Hereinafter, one or more embodiments will be described in detail with reference to the drawings. Each embodiment described below presents a general or specific example. The numerical values, shapes, materials, elements, the arrangement and connection of the elements, steps, the processing order of the steps etc., shown in the following embodiment are mere examples, and do not limit the scope of the present disclosure. Among the elements described in the following one or more embodiments, those not recited in any of the independent claims are described as optional elements. Moreover, the figures are schematic diagrams and are not necessarily precise illustrations. In the figures, elements that are essentially the same share the same reference signs, and repeated description may be omitted or simplified.

In the following description, ordinal numbers such as first, second, and third may be given to elements. These ordinal numbers are given to elements in order to distinguish between the elements, and thus do not necessarily correspond to an order that has intended meaning. Such ordinal numbers may be switched as appropriate, new ordinal numbers may be given, or the ordinal numbers may be removed.

In the following description, an acoustic signal included in sound information may be described, but the acoustic signal may be expressed as an audio signal or a sound signal. Stated differently, in the present disclosure, an acoustic signal has the same meaning as an audio signal or a sound signal.

### Embodiment

### Overview

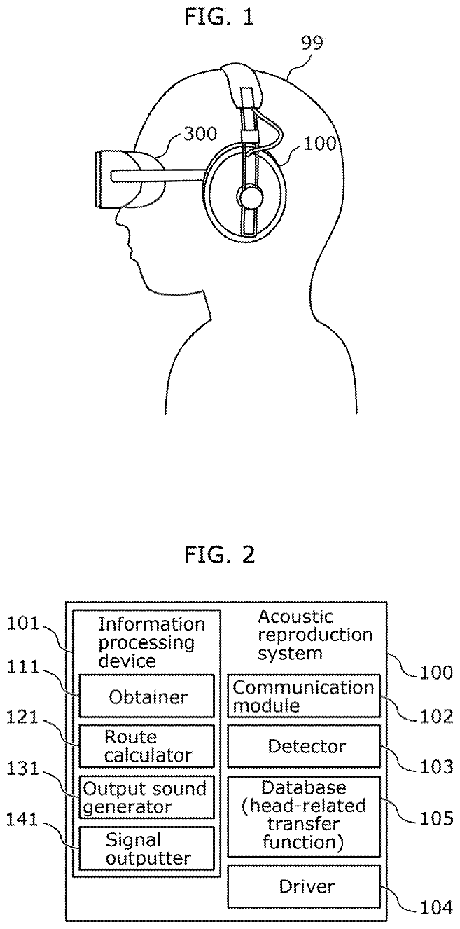

First, an overview of an acoustic reproduction system according to an embodiment will be described. FIG. 1 is a schematic diagram illustrating an example of use of an acoustic reproduction system according to the embodiment. FIG. 1 illustrates user 99 using acoustic reproduction system 100.

Acoustic reproduction system 100 illustrated in FIG. 1 is used simultaneously with stereoscopic image reproduction device 300, for example. By simultaneously viewing stereoscopic images and listening to three-dimensional sound, the images enhance the auditory sense of realism, and the sound enhances the visual sense of realism, allowing one to experience as if being at the scene where the images and sound were captured. For example, when an image (moving image) of people having a conversation is displayed, even if the localization of the sound image (sound source object) of the conversation sound is misaligned with the person's mouth, it is known that user 99 perceives it as conversation sound emitted from the person's mouth. In this manner, by combining images and sound, the position of the sound image may be corrected by visual information, thereby enhancing the sense of realism.

Stereoscopic image reproduction device 300 is an image display device worn on the head of user 99. Accordingly, stereoscopic image reproduction device 300 moves integrally with the head of user 99. For example, stereoscopic image reproduction device 300 is, as illustrated in the figure, a glasses-type device supported by the ears and nose of user 99.

Stereoscopic image reproduction device 300 changes the image to be displayed in response to the movement of the head of user 99, to cause user 99 to perceive as if he or she is moving their head within a three-dimensional image space. Stated differently, when an object within the three-dimensional image space is positioned in front of user 99, if user 99 turns to the right, the object moves to the left direction of user 99, and if user 99 turns to the left, the object moves to the right direction of user 99. Thus, stereoscopic image reproduction device 300 moves the three-dimensional image space in the opposite direction to the movement of user 99.

Stereoscopic image reproduction device 300 displays two images, each with a parallax shift, one to the left eye and the other to the right eye of user 99. User 99 can perceive the three-dimensional position of an object in the image based on the parallax shift of the displayed image. Note that when acoustic reproduction system 100 is used for the reproduction of healing sounds to induce sleep, or when user 99 uses it with their eyes closed, stereoscopic image reproduction device 300 does not need to be used simultaneously. Stated differently, stereoscopic image reproduction device 300 is not an essential element of the present disclosure. In addition to dedicated image display devices, there are cases where general-purpose portable terminals such as smartphones and tablet devices owned by user 99 are used for stereoscopic image reproduction device 300.

Such general-purpose portable terminals include various sensors for detecting the posture and movement of the terminal, in addition to a display for displaying images. Such general-purpose portable terminals also include a processor for information processing, enabling connection to a network for sending and receiving information with server devices such as cloud servers. Stated differently, stereoscopic image reproduction device 300 and acoustic reproduction system 100 can also be implemented by a combination of a smartphone and general-purpose headphones without information processing functions.

As in this example, the function for detecting head movement, the function for presenting images, the image information processing function for presentation, the function for presenting sound, and the sound information processing function for presentation may be appropriately arranged in one or more devices to implement stereoscopic image reproduction device 300 and acoustic reproduction system 100. When stereoscopic image reproduction device 300 is unnecessary, it suffices to appropriately arrange the function for detecting head movement, the function for presenting sound, and the sound information processing function for presentation in one or more devices. For example, acoustic reproduction system 100 can also be implemented by a processing device such as a computer or smartphone that includes the sound information processing function for presentation, and headphones or the like that include the function for detecting head movement and the function for presenting sound.

Acoustic reproduction system 100 is an audio presentation device worn on the head of user 99. Accordingly, acoustic reproduction system 100 moves integrally with the head of user 99. For example, acoustic reproduction system 100 according to the present embodiment is what is known as an over-ear headphone device. Note that the embodiment of acoustic reproduction system 100 is not particularly limited and may be, for example, two in-ear devices independently worn on the left and right ears of user 99.

Acoustic reproduction system 100 changes the sound to be presented in response to the movement of the head of user 99, to cause user 99 to perceive as if he or she is moving their head within a three-dimensional sound field. Thus, as described above, acoustic reproduction system 100 moves the three-dimensional sound field in the opposite direction to the movement of user 99.

Here, when user 99 moves within the three-dimensional sound field, the position of the sound source object relative to the position of user 99 in the three-dimensional sound field changes. As a result, it is necessary to generate output sound signals for reproduction by performing calculation processing based on the position of the sound source object and user 99 each time user 99 moves. Since such processes normally requires an enormous amount of processing, in the present disclosure, from the perspective of reducing the amount of processing, an output sound signal is generated and output in which a plurality of sound signals constituting the output sound signal to be subjected to convolution of the head-related transfer function are reduced. As a result, the number of sound signals subjected to convolution of the head-related transfer function is reduced, and thus a significant reduction in the processing amount is expected. In such cases, if the sound signals to be removed are determined by performing additional calculations, the processing amount increases by the amount of processing for the additional calculations, and thus it is preferable to determine which sound signals to remove using calculations that are as simple as possible. Therefore, in the present disclosure, the determination of which sound signals to remove is performed using only simple calculations by referring to a table calculated in advance. In this way, in the present disclosure, sounds to remove can be appropriately determined using only simple additional calculations, and the effect of reducing the processing amount obtained by reducing the sound signals can be made more pronounced.

### Structure

Next, a configuration of acoustic reproduction system 100 according to the present embodiment will be described with reference to FIG. 2. FIG. 2 is a block diagram illustrating the functional configuration of an acoustic reproduction system according to the embodiment.

As illustrated in FIG. 2, acoustic reproduction system 100 according to the present embodiment includes information processing device 101, communication module 102, detector 103, driver 104, and database 105.

Information processing device 101 is one example of an acoustic processing device, and is a computing device for executing various types of signal processing in acoustic reproduction system 100. Information processing device 101 includes a processor and memory, such as in a computer, and is implemented by the processor executing a program stored in the memory. The functions related to each functional element described below are realized by executing this program.

Information processing device 101 includes obtainer 111, route calculator 121, output sound generator 131, and signal outputter 141. Each functional element included in information processing device 101 will be described in detail below along with details regarding configurations other than information processing device 101.

Communication module 102 is an interface device for receiving input of sound information to acoustic reproduction system 100. For example, communication module 102 includes an antenna and a signal converter, and receives sound information from an external device via wireless communication. More specifically, communication module 102 receives, via the antenna, a wireless signal indicating sound information converted into a format for wireless communication, and reconverts the wireless signal into sound information using the signal converter. In this way, acoustic reproduction system 100 obtains sound information from the external device via wireless communication. Sound information obtained by communication module 102 is obtained by obtainer 111. In this way, obtainer 111 is one example of a sound obtainer. The sound information is input to information processing device 101 as described above. Communication between acoustic reproduction system 100 and the external device may be wired communication.

The sound information obtained by acoustic reproduction system 100 is, for example, encoded in a predetermined format such as MPEG-H 3D Audio (ISO/IEC 23008-3). As one example, encoded sound information includes information about reproduced sound that is reproduced by acoustic reproduction system 100 and information about a localization position when the sound image of the sound is localized at a predetermined position in a three-dimensional sound field (i.e., the sound is perceived as arriving from a predetermined direction). Sound information can also be interpreted as information about the sound source object. Stated differently, the sound information includes a position of the sound source object in the three-dimensional sound field and sound produced by the sound source object.

The sound information is obtained as input data as described above, and includes an audio signal (acoustic signal), which is information about reproduced sound, and information about the position of the sound source object in the three-dimensional sound field, which is other information. The other information may include information for defining the three-dimensional sound field. Therefore, there may be cases where the other information is collectively referred to as information related to space (spatial information), which includes information about the position of the sound source object and information for defining the three-dimensional sound field. When viewed from the perspective of the audio signal, the input data can be said to be sound information in which other information (metadata) is attached to the audio signal. When viewed from the perspective of the spatial information, the input data can be said to be information in which the audio signal is attached to the spatial information. Alternatively, the input data may be considered as sound space information, as it encompasses both of these aspects.

As one specific example, the sound information includes information related to a plurality of sounds including a first reproduced sound and a second reproduced sound, and the sound images are localized so that when each sound is reproduced, they are perceived as sounds arriving from different positions in a three-dimensional sound field. Therefore, the sound source object of the first reproduced sound is localized at a first position in the three-dimensional sound field, and the sound source object of the second reproduced sound is localized at a second position in the three-dimensional sound field. In this way, the sound information may include a plurality of sounds. Stated differently, the sound information may include a plurality of audio signals corresponding to the first reproduced sound and the second reproduced sound, respectively, and positions of a plurality of sound source objects at a first position and a second position that correspond one-to-one with the plurality of audio signals.

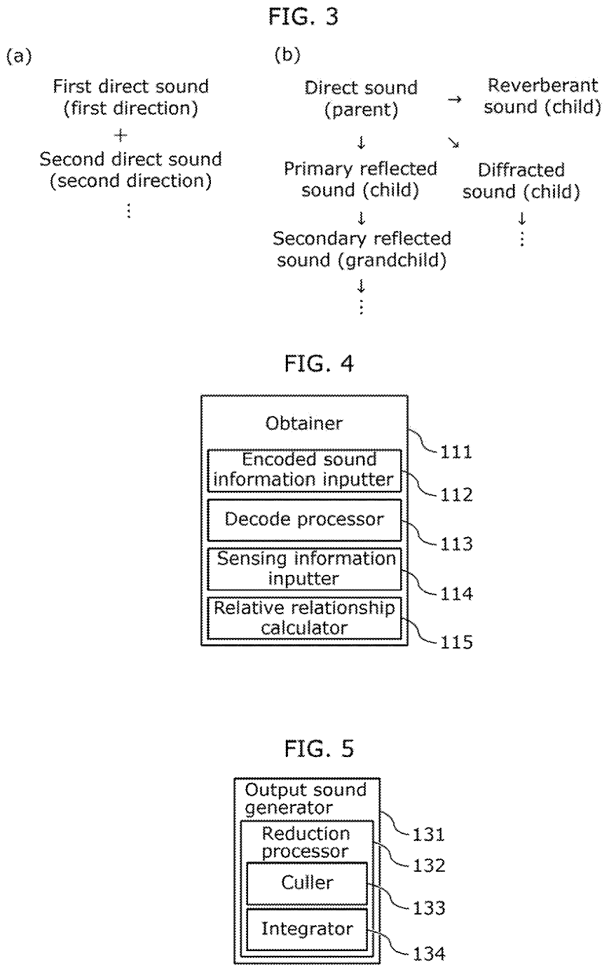

FIG. 3 is a diagram for explaining one example of an audio signal according to the embodiment. For example, as illustrated in (a) in FIG. 3, the sound information may include an audio signal of a first direct sound arriving at the position of user 99 from a first position (from a first direction) in advance, and an audio signal of a second direct sound arriving at the position of user 99 from a second position (from a second direction). Note that the sound information immediately after being obtained may include only information about the reproduced sound. In such cases, information related to the predetermined position may be separately obtained, and subsequent processing may be performed when such information is collected. As described above, the sound information includes first sound information related to the first reproduced sound and second sound information related to the second reproduced sound, but a plurality of items of sound information separately including these may be obtained respectively and simultaneously reproduced (that is, treated as one item of sound information) to localize sound images at different positions in the three-dimensional sound field and cause reproduced sounds to arrive from different directions.

Alternatively, the sound information may include a plurality of audio signals and a position of one sound source object that corresponds many-to-one with the plurality of audio signals. For example, such sound information is used in situations where a plurality of reproduced sounds are emitted from a certain sound source object. For example, each of the plurality of audio signals corresponds to direct sound that arrives directly from the position of the sound source object to the position of user 99, and secondary sound (sound generated by indirect propagation) that occurs along with the direct sound and arrives via a path different from the direct sound.

For example, as illustrated in (b) in FIG. 3, the sound information immediately after being obtained includes an audio signal related to direct sound, and is converted into sound information including audio signals of reverberant sound, primary reflected sound, diffracted sound, and the like by conversion processing that calculates secondary sounds. In the conversion processing that calculates this secondary sound, information on the conditions of the spatial environment of the three-dimensional sound field (for example, position of objects in the three-dimensional sound field, reflection, diffraction characteristics, etc.) is used. Thus, secondary sound is computationally generated from sound information related to one reproduced sound, based on the conditions of the spatial environment of the three-dimensional sound field, and therefore is not included in the sound information immediately after being obtained, and sound information including these secondary sounds is generated by conversion processing that calculates secondary sounds. From one secondary sound, another secondary sound may also be generated by the propagation of that secondary sound. Note that the information on the conditions of the spatial environment is a part of the spatial information, and may be obtained together with the audio signal by the input sound information. The audio signal and the spatial information may be obtained separately. Stated differently, the sound information may be obtained from a single file or bitstream, or may be obtained separately from a plurality of files or bitstreams. For example, the audio signal and the spatial information may be obtained from separate files or bitstreams, or each of the audio signal and the spatial information may be obtained from a plurality of files or bitstreams.

In the example of (b) in FIG. 3, generation of a secondary reflected sound from a primary reflected sound is illustrated. As illustrated in the figure, these secondary sounds are assigned tags that enable identification of mutual relationships such as parent, child, and grandchild, as information regarding the genealogy (in other words, generation lineage) of the generation relationship from the direct sound. Alternatively, when the direct sound is designated as generation 0, the generation number may be quantified as generation 1 to which the primary reflected sound belongs, generation 2 to which the secondary reflected sound belongs, and so on. Note that how many generations of generation from the direct sound are permitted may be settable according to the scale of computational resources.

Thus, the form of the input sound information is not particularly limited, and acoustic reproduction system 100 may include obtainer 111 corresponding to various forms of sound information.

Here, one example of obtainer 111 will be described with reference to FIG. 4. FIG. 4 is a block diagram illustrating the functional configuration of an obtainer according to the embodiment. As illustrated in FIG. 4, obtainer 111 according to the present embodiment includes, for example, encoded sound information inputter 112, decode processor 113, sensing information inputter 114, and relative relationship calculator 115.

Encoded sound information inputter 112 is a processor into which encoded sound information obtained by obtainer 111 is input. Encoded sound information inputter 112 outputs the input sound information to decode processor 113. Decode processor 113 is a processor that generates reproduced sound included in the sound information and a position of the sound source object in a format to be used in subsequent processing by decoding the sound information output from encoded sound information inputter 112. Sensing information inputter 114 will be described below along with the function of detector 103.

Detector 103 is for detecting the movement speed of the head of user 99. Detector 103 includes a combination of various sensors used for detecting movement, such as a gyro sensor and an acceleration sensor. In the present embodiment, detector 103 is provided in acoustic reproduction system 100, but it may be provided in an external device, such as stereoscopic image reproduction device 300 that operates in response to the movement of the head of user 99, similarly to acoustic reproduction system 100. In such cases, detector 103 need not be included in acoustic reproduction system 100. Detector 103 may be an external imaging device or the like that captures images of the movement of the head of user 99, and the movement of user 99 may be detected by processing the captured images.

Detector 103 is, for example, integrally fixed to the housing of acoustic reproduction system 100, and detects the movement speed of the housing. Acoustic reproduction system 100 including the above-mentioned housing, after being worn by user 99, moves integrally with the head of user 99, and therefore detector 103 can detect the movement speed of the head of user 99.

Detector 103 may, for example, detect a rotation amount with at least one of three mutually orthogonal axes in three-dimensional space as a rotation axis, or detect a displacement amount with at least one of the three axes as a displacement direction, as an amount of movement of the head of user 99. Detector 103 may also detect both the rotation amount and the displacement amount as the amount of movement of the head of user 99.

Sensing information inputter 114 obtains the movement speed of the head of user 99 from detector 103. More specifically, sensing information inputter 114 obtains, as the movement speed, the amount of movement of the head of user 99 detected by detector 103 per unit time. In this way, sensing information inputter 114 obtains at least one of the rotation speed or the displacement speed from detector 103. Here, the amount of movement of the head of user 99 that is obtained is used to determine the position and posture (in other words, the coordinates and orientation) of user 99 in the three-dimensional sound field. Therefore, obtainer 111 also functions as a position obtainer by means of sensing information inputter 114. In acoustic reproduction system 100, sound is reproduced by determining the relative position of the sound image object with respect to user 99 based on the determined coordinates and orientation of user 99. More specifically, the above-mentioned functions are realized by route calculator 121 and output sound generator 131.

Route calculator 121 includes a direction of arrival calculation function that calculates, based on the determined coordinates and orientation of user 99, a relative direction of arrival of the reproduced sound arriving at the position of user 99 from the position of the sound source object, and a conversion process that calculates the secondary sound described above. Therefore, route calculator 121 includes a function that calculates a propagation route from the sound source object, and calculates (i) a secondary sound arriving at the position of user 99 by indirect propagation of the reproduced sound according to the calculated propagation route of the reproduced sound and (ii) the direction of arrival of the secondary sound. The direction of arrival of the secondary sound includes additional information such as what kind of object caused the reflection in the case of reflected sound, and to what degree the attenuation rate is at the time of reflection. The additional information is included in the direction of arrival of the secondary sound calculated by the input sound information. Stated differently, the additional information is computationally generated and obtained from the sound information.

To summarize the spatial information: it includes the spatial position of the sound source object in the space (three-dimensional sound field) (information about the position of the sound source object), reflection and diffraction characteristics of sound at the sound source object (collectively, information on the conditions of the spatial environment), and additional information such as the size of the three-dimensional sound field. Based on spatial information, route calculator 121 generates secondary sounds that result from reflection or diffraction of the reproduced sound off various sound source objects. It then calculates additional information such as the direction of arrival of these secondary sounds and their volume levels after attenuation caused by the reflection or diffraction. The sound information (input data) includes spatial information in the form of metadata attached to the audio signal, and this spatial information includes, as described above, information other than the audio signal, such as information necessary for positioning the sound source object in the three-dimensional sound field by making the sound three-dimensional, and/or information used to calculate the information necessary for positioning the sound source object in the three-dimensional sound field by making the sound three-dimensional.

Route calculator 121 may be realized by any process as long as it can calculate the direction of arrival of the reproduced sound when the reproduced sound reaches the user as direct sound, and calculate the secondary sound arriving at the position of user 99 by secondary propagation of the reproduced sound, together with its direction of arrival. Route calculator 121 determines, from which direction in the three-dimensional sound field to cause user 99 to perceive the reproduced sound and secondary sound as arriving, based on the coordinates and orientation of user 99, and processes the sound information such that, when the output sound signal is reproduced, it is perceived as such a sound.

Output sound generator 131 is a processor that generates an output sound signal by processing information related to reproduced sound included in the sound information.

Here, one example of output sound generator 131 will be described with reference to FIG. 5. FIG. 5 is a block diagram illustrating the functional configuration of an output sound generator according to the embodiment. As illustrated in FIG. 5, output sound generator 131 according to the present embodiment includes, for example, reduction processor 132, and reduction processor 132 includes culler 133 and integrator 134.

Reduction processor 132 is a processor that reduces certain sound signals. Through processing of sound information by route calculator 121 and the like, a plurality of sound signals are generated representing several sounds until sound from a certain sound source object arrives at user 99. These sounds include direct sound as well as indirect sounds such as reverberant sound, reflected sound (primary, secondary, and subsequent higher-order), and diffracted sound. Reduction processor 132 determines, from among these plurality of sound signals, those sound signals that are unlikely to produce an audible difference even if removed, that is, sound signals whose degradation is difficult for user 99 to perceive, and removes those signals.

Reduction processor 132 uses culler 133 to stop generation of sound signals, or performs culling processing that discards generated sound signals, thereby preventing those sound signals from being included in subsequent output sound signals. Culler 133 is thus a processor that discards specific sound signals that have been determined as sounds to remove. Note that discarding here refers to discarding in a broad sense that also includes discarding of signals by stopping generation itself.

Reduction processor 132 uses integrator 134 to discard two or more sound signals, and instead performs integration processing that generates one or more virtual sounds that virtually replace the two or more sounds by integrating the discarded sound signals into a smaller number of virtual sounds, thereby preventing those two or more sound signals from being included in subsequent output sound signals, and instead causing a smaller number of virtual sound signals to be included in subsequent output sound signals. Integrator 134 is thus a processor that discards specific two or more sound signals that have been determined as sounds to remove, and instead generates a smaller number of virtual sound signals to replace them.

Reduction processor 132 determines, based on a sound source object and a user, specific sound signals to remove from among a plurality of sound signals based on a preset importance level (also expressed as priority level). For example, reduction processor 132 performs processing such as removing sound signals whose priority level is less than a threshold value by culling processing, or removing two or more sound signals whose priority level is less than a threshold value by integration processing and generating and synthesizing virtual sounds to replace the two or more sounds.

Here, reduction processor 132 performs sound reduction processing according to the relative relationship between the respective states of the sound source object and the user calculated by relative relationship calculator 115 illustrated in FIG. 4. More specifically, relative relationship calculator 115 calculates a relative relationship (first relative relationship) at a certain time point (time t) that is calculated from at least one of the position states or orientation states of the sound source object at that time point and the user at the same time point. Relative relationship calculator 115 also calculates a relative relationship (second relative relationship) at a subsequent time point (time t+Δt) that is amount of time Δt after a certain time point that is calculated from at least one of the position states or orientation states of the sound source object at that time point and the user at the same time point.

If the difference in the relative relationships (e.g., difference in position or difference in orientation) between the first relative relationship and the second relative relationship is relatively small, user 99 is unlikely to notice even if the same sound is removed at these two time points. Stated differently, sound signals can be removed with little sense of unnaturalness. For example, even if sounds to be removed at a subsequent time point are removed in advance at a certain time point, user 99 is unlikely to feel a sense of unnaturalness, and thus it is easier to remove a greater number of sound signals at a certain time point, and a significant reduction in processing load can be expected. However, there are cases where it is not suitable to apply the above-described reduction processing, such as when the sounds to be removed at the two time points differ significantly. Such cases will be described in greater detail in the examples described later.

We will now refer again to FIG. 2. Output sound generator 131 obtains the head-related transfer function used for generating the output sound signal from database 105. Database 105 is an information storage device that serves a dual function, namely, as a memory device for storing information and also as a storage controller that reads out stored information and outputs it to an external component. Database 105 stores the head-related transfer function for each direction of arrival to user 99. Included in database 105 is a set of general-purpose head-related transfer functions that can be used for everyone, or a set of head-related transfer functions optimized for user 99 individually, or a set of head-related transfer functions that are publicly available. Database 105 receives a query from output sound generator 131 specifying the direction of arrival, and outputs the head-related transfer function corresponding to that direction of arrival to output sound generator 131. Output sound generator 131 may also output all sets of head-related transfer functions or output characteristics of the head-related transfer function set itself.

Signal outputter 141 is a functional element that outputs the generated output sound signal to driver 104. Signal outputter 141 generates a waveform signal by performing digital-to-analog signal conversion based on the output sound signal, causes driver 104 to generate sound waves based on the waveform signal, and presents sound to user 99. Driver 104 includes, for example, a diaphragm and a driving mechanism such as a magnet and a voice coil. Driver 104 operates the driving mechanism in accordance with the waveform signal, and causes the diaphragm to vibrate via the driving mechanism. In this way, driver 104 generates sound waves by vibrating the diaphragm in accordance with the output sound signal (meaning to “reproduce” the output sound signal, that is, user 99 perceiving it is not included in the meaning of “reproduction”), the sound waves propagate through the air and are transmitted to user 99's ears, and user 99 perceives the sound.

### Other Configuration Examples

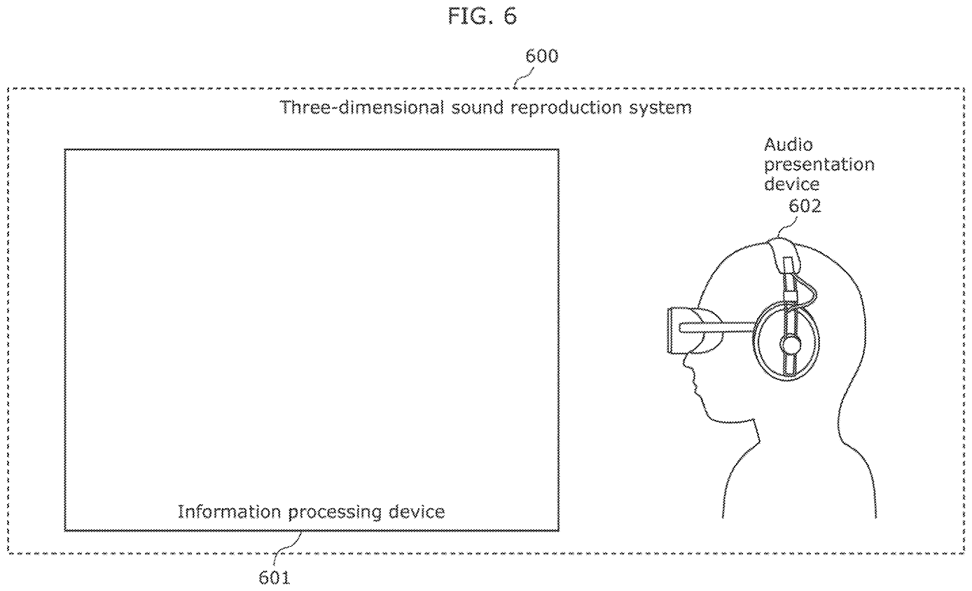

In the above example, while it has been described that acoustic reproduction system 100 according to the present embodiment is an audio presentation device and includes information processing device 101, communication module 102, detector 103, database 105, and driver 104, the functions of acoustic reproduction system 100 may be implemented by a plurality of devices or may be implemented by a single device. Specifically, this will be described with reference to FIG. 6 through FIG. 14. FIG. 6 through FIG. 14 are diagrams for explaining another example of an acoustic reproduction system according to an embodiment.

For example, information processing device 601 may be included in audio presentation device 602, and audio presentation device 602 may perform both acoustic processing and sound presentation. The acoustic processing described in the present disclosure may be divided between information processing device 601 and audio presentation device 602 and performed, or a server connected via a network to information processing device 601 or audio presentation device 602 may perform part or all of the acoustic processing described in the present disclosure.

Although the naming “information processing device” 601 is used in the above description, when information processing device 601 performs acoustic processing by decoding a bitstream generated by encoding at least a portion of data of an audio signal or spatial information used for acoustic processing, information processing device 601 may be called a decoding device, or acoustic reproduction system 100 (i.e., three-dimensional sound reproduction system 600 in the figures) may be called a decoding processing system.

Here, an example in which acoustic reproduction system 100 functions as a decoding processing system will be described.

### Encoding Device Example

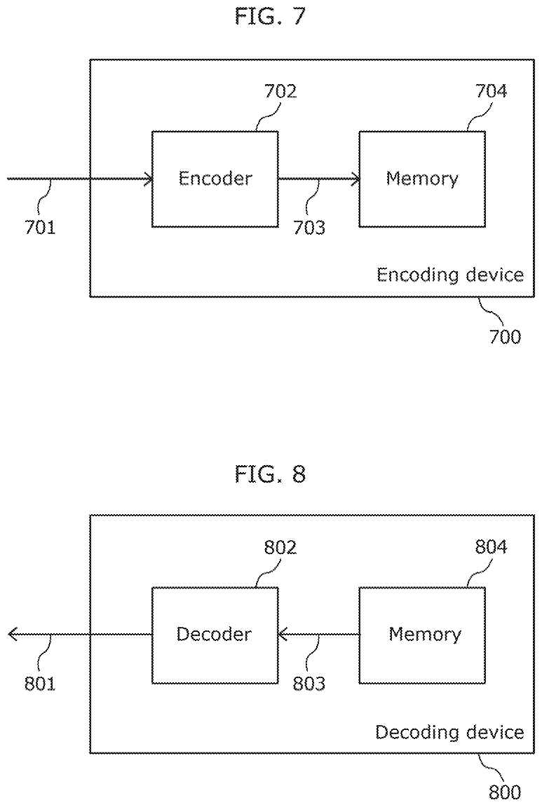

FIG. 7 is a functional block diagram illustrating the configuration of encoding device 700, which is one example of an encoding device of the present disclosure.

Input data 701 is data to be encoded that includes spatial information and/or an audio signal to be input to encoder 702. The spatial information will be described in greater detail later.

Encoder 702 encodes input data 701 to generate encoded data 703. Encoded data 703 is, for example, a bitstream generated by the encoding process.

Memory 704 stores encoded data 703. Memory 704 may be, for example, a hard disk or a solid-state drive (SSD), or may be any other type of memory device.

Although a bitstream generated by the encoding process was given as one example of encoded data 703 stored in memory 704 in the above description, encoded data 703 may be data other than a bitstream. For example, encoding device 700 may store, in memory 704, converted data generated by converting the bitstream into a predetermined data format. The data after conversion may be, for example, a file storing one or a plurality of bitstreams or a multiplexed stream. Here, the file is, for example, a file having a file format such as ISOBMFF (ISO Base Media File Format). Encoded data 703 may be in the form of a plurality of packets generated by dividing the above-mentioned bitstream or file. When the bitstream generated by encoder 702 is to be converted into data different from the bitstream, encoding device 700 may include a converter not shown in the figure, or may perform the conversion process using a central processing unit (CPU).

### Decoding Device Example

FIG. 8 is a functional block diagram illustrating the configuration of decoding device 800, which is one example of a decoding device of the present disclosure.

Memory 804 stores, for example, the same data as encoded data 703 generated by encoding device 700. Memory 804 reads the stored data and inputs it as input data 803 to decoder 802. Input data 803 is, for example, a bitstream to be decoded. Memory 804 may be, for example, a hard disk or an SSD, or may be any other type of memory device.

Decoding device 800 may use, as input data 803, converted data generated by converting the data read from memory 804, rather than directly using the data stored in memory 804 as input data 803. The data before conversion may be, for example, multiplexed data storing one or a plurality of bitstreams. Here, the multiplexed data may be, for example, a file having a file format such as ISOBMFF. Pre-conversion data may be in the form of a plurality of packets generated by dividing the above-mentioned bitstream or file. When converting data different from the bitstream read from memory 804 into a bitstream, decoding device 800 may include a converter not shown in the figure, or may perform the conversion process using a CPU.

Decoder 802 decodes input data 803 to generate audio signal 801 to be presented to a listener.

### Another Example of Encoding Device

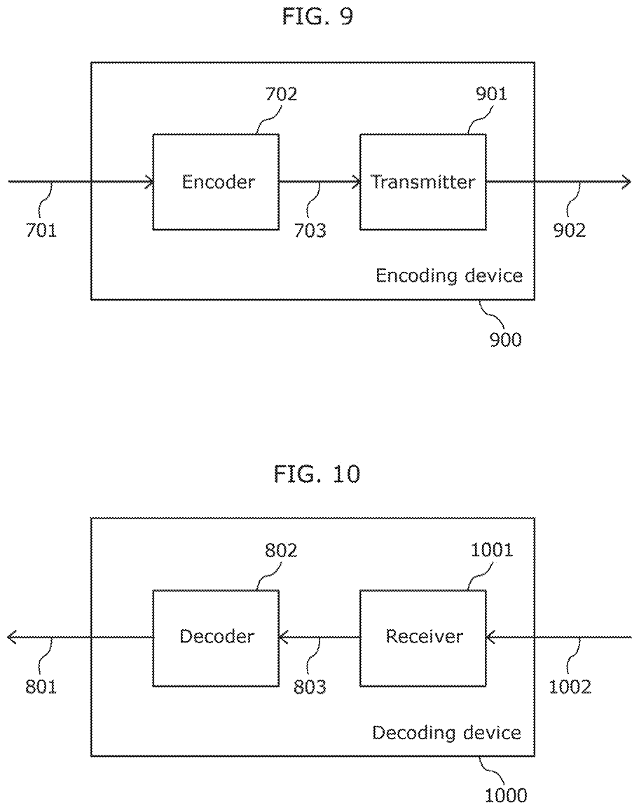

FIG. 9 is a functional block diagram illustrating the configuration of encoding device 900, which is another example of an encoding device of the present disclosure. In FIG. 9, the same reference numerals are assigned to configurations having the same functions as those in FIG. 7, and repeated explanation of these configurations will be omitted.

Encoding device 900 differs from encoding device 700 in that while encoding device 700 includes memory 704 that stores encoded data 703, encoding device 900 includes transmitter 901 that transmits encoded data 703 to an external destination.

Transmitter 901 transmits transmission signal 902 to another device or server based on encoded data 703 or data in another data format generated by converting encoded data 703. The data used for generating transmission signal 902 is, for example, the bitstream, multiplexed data, file, or packet explained in regard to encoding device 700.

### Another Example of Decoding Device

FIG. 10 is a functional block diagram illustrating the configuration of decoding device 1000, which is another example of a decoding device of the present disclosure. In FIG. 10, the same reference numerals are assigned to configurations having the same functions as those in FIG. 8, and repeated explanation of these configurations will be omitted.

Decoding device 1000 differs from decoding device 800 in that while decoding device 800 reads input data 803 from memory 804, decoding device 1000 includes receiver 1001 that receives input data 803 from an external source.

Receiver 1001 receives reception signal 1002 thereby obtaining reception data, and outputs input data 803 to be input to decoder 802. The reception data may be the same as input data 803 input to decoder 802, or may be data in a data format different from input data 803. When the reception data is data in a data format different from input data 803, receiver 1001 may convert the reception data to input data 803, or a converter not shown in the figure or a CPU included in decoding device 1000 may convert the reception data to input data 803. The reception data is, for example, the bitstream, multiplexed data, file, or packet explained in regard to encoding device 900.

### Explanation of Functions of Decoder

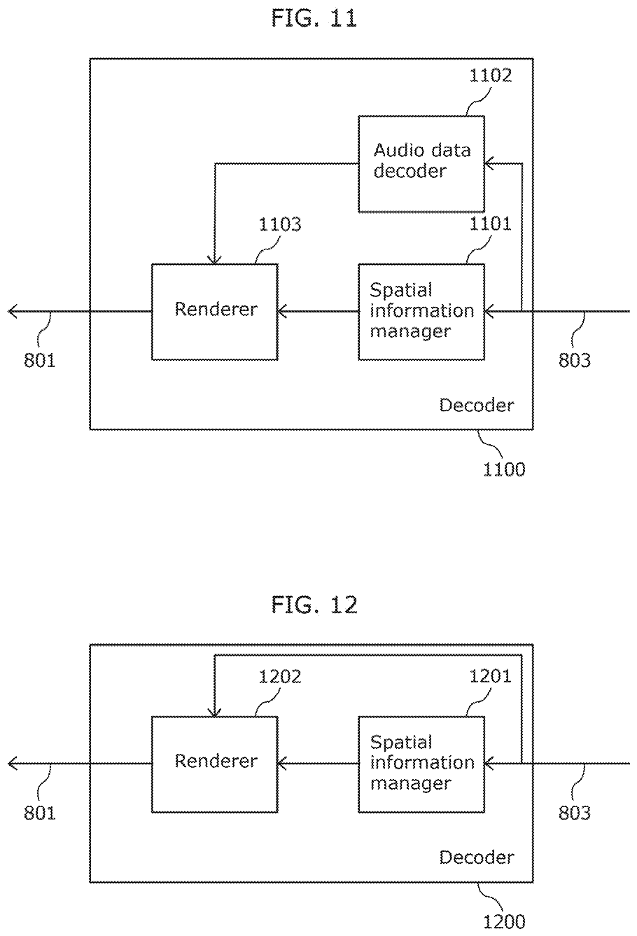

FIG. 11 is a functional block diagram illustrating the configuration of decoder 1100, which is one example of decoder 802 in FIG. 8 or FIG. 10.

Input data 803 is an encoded bitstream and includes encoded audio data, which is an encoded audio signal, and metadata used for acoustic processing.

Spatial information manager 1101 obtains metadata included in input data 803, and analyzes the metadata. The metadata includes information describing elements placed in the sound space that act on sounds. Spatial information manager 1101 manages spatial information necessary for acoustic processing obtained by analyzing the metadata, and provides the spatial information to renderer 1103. Note that in the present disclosure, the information used for acoustic processing is referred to as spatial information, but this information may be referred to be some other name. The information used for this acoustic processing may be referred to as, for example, sound space information or scene information. When the information used for acoustic processing changes over time, the spatial information input to renderer 1103 may be referred to as a spatial state, a sound space state, a scene state, or the like.

The spatial information may be managed per sound space or per scene. For example, when expressing different rooms as virtual spaces, each room may be managed as a scene of a different sound space, or even for the same space, the spatial information may be managed as different scenes depending on the scene being expressed. In the management of spatial information, an identifier for identifying (distinguishing between) each item of spatial information may be assigned. The spatial information data may be included in a bitstream, which is one form of input data 803, or the bitstream may include an identifier of the spatial information, and the spatial information data may be obtained from somewhere other than the bitstream. When the bitstream includes only the identifier of the spatial information, at the time of rendering, the spatial information data stored in the memory of the acoustic signal processing device or in an external server may be obtained as input data using the identifier of the spatial information.

Note that the information managed by spatial information manager 1101 is not limited to information included in the bitstream. For example, input data 803 may include data indicating characteristics or structure of a space obtained from a VR or AR software application or server as data not included in the bitstream. For example, input data 803 may include data indicating characteristics or a position of a listener or object as data not included in the bitstream. Input data 803 may include information obtained by a sensor included in a terminal that includes the decoding device as information indicating the position of the listener, or information indicating the position of the terminal estimated based on information obtained by the sensor. That is, spatial information manager 1101 may communicate with an external system or server and obtain spatial information and the position of the listener. Spatial information manager 1101 may obtain clock synchronization information from an external system and execute a process to synchronize with the clock of renderer 1103. The space in the above explanation may be a virtually formed space, that is, a VR space, or it may be a real space or a virtual space corresponding to a real space, that is, an AR space or a mixed reality (MR) space. The virtual space may be called a sound field or sound space. The information indicating position in the above description may be information such as coordinate values indicating a position in space, or may be information indicating a relative position with respect to a predetermined reference position, or may be information indicating movement or acceleration of a position in space.

Audio data decoder 1102 decodes encoded audio data included in input data 803 to obtain an audio signal.

The encoded audio data obtained by three-dimensional sound reproduction system 600 is, for example, a bitstream encoded in a predetermined format such as MPEG-H 3D Audio (ISO/IEC 23008-3). MPEG-H 3D Audio is merely one example of an encoding method that can be used when generating encoded audio data included in the bitstream, and the bitstream may include encoded audio data encoded using other encoding methods. For example, the encoding method used may be a lossy codec such as MP3 (MPEG-1 Audio Layer-3), AAC (Advanced Audio Coding), WMA (Windows Media Audio), AC3 (Audio Codec-3), or Vorbis, or may be a lossless codec such as ALAC (Apple Lossless Audio Codec) or FLAC (Free Lossless Audio Codec), or any other encoding method other than those mentioned above may be used. For example, PCM (Pulse Code Modulation) data may be one type of encoded audio data. In such cases, the decoding process may, for example, when the number of quantization bits of PCM data is N, convert the N-bit binary number into a numerical format (for example, floating-point format) that can be processed by renderer 1103.

Renderer 1103 receives an audio signal and spatial information as inputs, applies acoustic processing to the audio signal using the spatial information, and outputs acoustic-processed audio signal 801.

Before starting rendering, spatial information manager 1101 reads metadata of the input signal, detects rendering items such as objects or sounds specified by the spatial information, and transmits the detected rendering items to renderer 1103. After rendering starts, spatial information manager 1101 obtains the temporal changes in the spatial information and the listener's position, and updates and manages the spatial information. Spatial information manager 1101 then transmits the updated spatial information to renderer 1103. Renderer 1103 generates and outputs an audio signal with acoustic processing added based on the audio signal included in the input data and the spatial information received from spatial information manager 1101.

The update processing of the spatial information and the output processing of the audio signal added with acoustic processing may be executed in the same thread, or spatial information manager 1101 and renderer 1103 may be allocated to respective independent threads. The update processing of the spatial information and the output processing of the audio signal added with acoustic processing may be processed in different threads, and the activation frequency of the threads may be set individually, or the processing may be executed in parallel.

By executing processing in different independent threads for spatial information manager 1101 and renderer 1103, computational resources can be preferentially allocated to renderer 1103, allowing for safe implementation even in cases of sound output processing where even slight delays cannot be tolerated, for example, sound output processing where a popping noise occurs if there is a delay of even one sample (0.02 msec). In this case, allocation of computational resources to spatial information manager 1101 is restricted. However, the update of the spatial information is a low-frequency process (for example, a process such as updating the orientation of the listener's face) compared to the output processing of the audio signal. Therefore, since it is not necessarily required to respond instantaneously like the output processing of the audio signal, even if allocation of computational resources is restricted, there is no significant impact on the acoustic quality provided to the listener.

The update of the spatial information may be executed periodically at predetermined times or intervals, or may be executed when a predetermined condition is met. The update of the spatial information may be executed manually by the listener or the manager of the sound space, or may be triggered by changes in an external system. For example, when the listener operates a controller to instantly warp the position of their avatar, rapidly advance or rewind time, or when the manager of the virtual space suddenly changes the environment of the scene as a production effect, the thread in which spatial information manager 1101 is arranged may be activated as a one-time interrupt process in addition to periodic activation.

The role of the information update thread that executes the update processing of the spatial information is, for example, processing to update the position or orientation of the listener's avatar placed in the virtual space based on the position or orientation of the VR goggles worn by the listener, and updating the position of objects moving within the virtual space, and is handled within a processing thread that activates at a relatively low frequency of approximately several tens of Hz. Such processing that reflects the characteristics of direct sound may be performed in a processing thread with a low occurrence frequency. This is because the frequency at which the characteristics of direct sound change is lower than the frequency of occurrence of audio processing frames for audio output. Rather, by doing so, the computational load of this processing can be relatively reduced, and the risk of pulsive noise occurring due to unnecessarily frequent information updates can be avoided.

FIG. 12 is a functional block diagram illustrating the configuration of decoder 1200, which is another example of decoder 802 in FIG. 8 or FIG. 10.

FIG. 12 differs from FIG. 11 in that input data 803 includes an unencoded audio signal rather than encoded audio data. Input data 803 includes an audio signal and a bitstream including metadata.

Spatial information manager 1201 is the same as spatial information manager 1101 in FIG. 11, so repeated explanation is omitted.

Renderer 1202 is the same as renderer 1103 in FIG. 11, so repeated explanation is omitted.

Note that while the configuration in FIG. 12 is referred to as a decoder in the above description, it may also be called an acoustic processor that performs acoustic processing. Moreover, a device including the acoustic processor may be called an acoustic processing device rather than a decoding device. Acoustic signal processing device (information processing device 601) may be called an acoustic processing device.

### Physical Configuration of Encoding Device

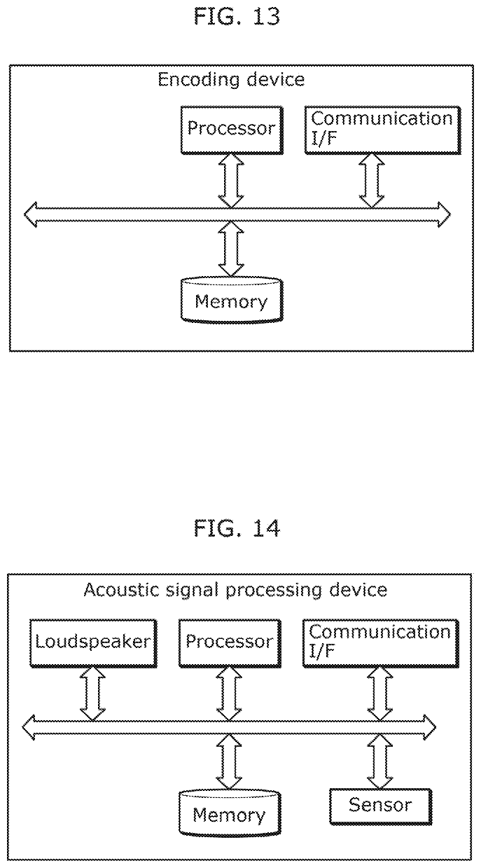

FIG. 13 illustrates one example of a physical configuration of the encoding device. The encoding device illustrated in FIG. 13 is one example of the above-mentioned encoding devices 700 and 900.

The encoding device of FIG. 13 includes a processor, memory, and a communication I/F.

The processor is, for example, a central processing unit (CPU) or digital signal processor (DSP) or graphics processing unit (GPU), and the encoding processing according to the present disclosure may be performed by the CPU or DSP or GPU executing a program stored in the memory. The processor may also be a dedicated circuit that performs signal processing on an audio signal including the encoding processing according to the present disclosure.

The memory includes, for example, random access memory (RAM) or read only memory (ROM). The memory may include magnetic storage media such as a hard disk, or semiconductor memory such as a solid-state drive (SSD). Moreover, the term “memory” may include internal memory incorporated in a CPU or GPU.

The communication I/F (interface) is, for example, a communication module corresponding to communication methods such as Bluetooth (registered trademark) or WiGig (registered trademark). The encoding device includes a function to communicate with other communication devices via the communication I/F, and transmits an encoded bitstream.

The communication module includes, for example, a signal processing circuit and an antenna that correspond to the communication method. In the above example, Bluetooth (registered trademark) or WiGig (registered trademark) were cited as examples of communication methods, but the communication method may support Long Term Evolution (LTE), New Radio (NR), or Wi-Fi (registered trademark). Moreover, the communication I/F may be a wired communication method such as Ethernet (registered trademark), Universal Serial Bus (USB), or High-Definition Multimedia Interface (HDMI) (registered trademark), rather than the wireless communication methods described above.

### Physical Configuration of Acoustic Signal Processing Device

FIG. 14 illustrates one example of a physical configuration of the acoustic signal processing device. Note that the acoustic signal processing device in FIG. 14 may be a decoding device. A portion of the configuration described here may be included in audio presentation device 602. The acoustic signal processing device illustrated in FIG. 14 is one example of the above-mentioned acoustic signal processing device 601.

The acoustic signal processing device of FIG. 14 includes a processor, memory, a communication I/F, a sensor, and a loudspeaker.

The processor is, for example, a central processing unit (CPU) or digital signal processor (DSP) or graphics processing unit (GPU), and the acoustic processing or decoding processing according to the present disclosure may be performed by the CPU or DSP or GPU executing a program stored in the memory. The processor may also be a dedicated circuit that performs signal processing on an audio signal including the acoustic processing according to the present disclosure.

The memory includes, for example, random access memory (RAM) or read only memory (ROM). The memory may include magnetic storage media such as a hard disk, or semiconductor memory such as a solid-state drive (SSD). Moreover, the term “memory” may include internal memory incorporated in a CPU or GPU.

The communication I/F (interface) is, for example, a communication module corresponding to communication methods such as Bluetooth (registered trademark) or WiGig (registered trademark). The acoustic signal processing device illustrated in FIG. 2I includes a function to communicate with other communication devices via the communication I/F, and obtains a bitstream to be decoded. The obtained bitstream is, for example, stored in memory.

The communication module includes, for example, a signal processing circuit and an antenna that correspond to the communication method. In the above example, Bluetooth (registered trademark) or WiGig (registered trademark) were cited as examples of communication methods, but the communication method may support Long Term Evolution (LTE), New Radio (NR), or Wi-Fi (registered trademark). Moreover, the communication I/F may be a wired communication method such as Ethernet (registered trademark), Universal Serial Bus (USB), or High-Definition Multimedia Interface (HDMI) (registered trademark), rather than the wireless communication methods described above.

The sensor performs sensing to estimate the position or orientation of the listener. More specifically, the sensor estimates the position and/or orientation of the listener based on one or a plurality of detection results of the position, orientation, movement, velocity, angular velocity, or acceleration of a part or all of the listener's body, such as the listener's head, and generates position information indicating the position and/or orientation of the listener. The position information may be information indicating the position and/or orientation of the listener in real space, or may be information indicating the displacement of the position and/or orientation of the listener with respect to the position and/or orientation of the listener at a predetermined time point. The position information may be information indicating the position and/or orientation relative to the three-dimensional sound reproduction system or an external device including a sensor.

The sensor may be, for example, an imaging device such as a camera or a distance measuring device such as Light Detection And Ranging (LIDAR), and may capture images of the movement of the head of the listener, and detect the movement of the head of the listener by processing the captured images. As the sensor, a device that performs position estimation using wireless communication in any frequency band, such as millimeter waves, may be used.

Note that the acoustic signal processing device illustrated in FIG. 14 may obtain position information via the communication I/F from an external device including a sensor. In such cases, the acoustic signal processing device need not include a sensor. Here, an external device refers to, for example, audio presentation device 602 described in FIG. 6, or a stereoscopic image reproduction device worn on the listener's head. The sensor includes, for example, a combination of various sensors such as a gyro sensor and an acceleration sensor.

The sensor may, for example, detect an angular velocity of rotation with at least one of three mutually orthogonal axes in the sound space as a rotation axis, or detect an acceleration of displacement with at least one of the three axes as a displacement direction, as a velocity of movement of the head of the listener.

The sensor may, for example, detect a rotation amount with at least one of three mutually orthogonal axes in the sound space as a rotation axis, or detect a displacement amount with at least one of the three axes as a displacement direction, as an amount of movement of the head of the listener. More specifically, the sensor detects the listener's position as 6DoF (position (x, y, z) and angle (yaw, pitch, roll)). The sensor includes a combination of various sensors used for detecting movement, such as a gyro sensor and an acceleration sensor.

The sensor may be implemented by a camera or a Global Positioning System (GPS) receiver, as long as it can detect the listener's position. Position information obtained by performing self-position estimation using Laser Imaging Detection and Ranging (LIDAR) or the like may be used. For example, when the audio signal reproduction system is implemented by a smartphone, the sensor is built into the smartphone.

The sensor may include a temperature sensor such as a thermocouple that detects the temperature of the acoustic signal processing device illustrated in FIG. 14, and a sensor that detects the remaining level of a battery included in or connected to the acoustic signal processing device.

The loudspeaker includes, for example, a diaphragm, a driving mechanism such as a magnet or a voice coil, and an amplifier, and presents the acoustic-processed audio signal as sound to the listener. The loudspeaker operates the driving mechanism in accordance with the audio signal amplified via the amplifier (more specifically, a waveform signal indicating the waveform of sound), and causes the diaphragm to vibrate via the driving mechanism. In this way, the diaphragm vibrating in accordance with the audio signal generates sound waves, the sound waves propagate through the air and are transmitted to the listener's ears, and the listener perceives the sound.

Note that while the acoustic signal processing device illustrated in FIG. 14 has been described as an example where it includes a loudspeaker and presents the acoustic-processed audio signal via the loudspeaker, the means for presenting the audio signal is not limited to the above configuration. For example, the acoustic-processed audio signal may be output to external audio presentation device 602 connected via a communication module. The communication performed by the communication module may be wired or wireless. As another example, the acoustic signal processing device illustrated in FIG. 14 may include a terminal that outputs an analog signal of audio, and the audio signal may be presented from earphones or the like by connecting the earphones cable to the terminal. In this case, audio presentation device 602, such as headphones, earphones, a head-mounted display, neck speakers, wearable speakers worn on the listener's head or a part of the body, or surround speakers configured with a plurality of fixed speakers, reproduces the audio signal.

### Explanation of Functions of Renderer, Examples

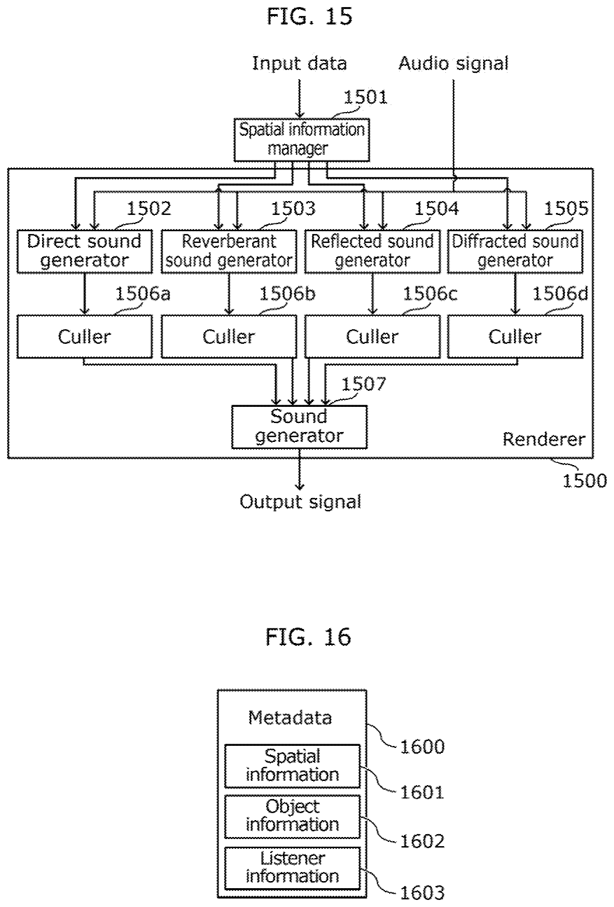

Hereinafter, examples of detailed configurations of renderers 1103 and 1202 illustrated in FIG. 11 and FIG. 12 will be given. FIG. 15 through FIG. 33 are diagrams for explaining a specific example of an acoustic reproduction system according to an example of the embodiment.

In the present example, when removing sounds for a listener (user 99) at a position and orientation at time t, sounds are removed according to the relative relationship between the position and orientation of the listener and the position and orientation of the sound source object at the same time (hereinafter also referred to as relative relationship of states), and additionally, by calculating through predicting the movement of the listener after amount of time Δt, sounds are also removed according to the relative relationship between the position and orientation of the listener and the position and orientation of the sound source object at time t+Δt.

For example, by calculating through predicting the position of the listener after amount of time Δt from the movement history up to that point, sounds that fall below the loudness threshold at the position after amount of time Δt are removed from the candidates for sounds not to be removed at time t, that is, they are removed. This is based on the idea that sounds that will become inaudible after amount of time Δt are considered to have little impact even at time t, and by also removing, at time t, sounds that will become inaudible at the estimated position at time t+Δt, it is possible to obtain the advantageous effect of a reduction in processing amount while inhibiting degradation of sound quality.

FIG. 15 will be described. FIG. 15 is a block diagram of a decoder according to the present example (i.e., renderer 1500 and spatial information manager 1501). The basic idea of the present example is that sounds that will become inaudible after amount of time Δt (hereinafter, Δt is a duration in which the listener is unlikely to perceive a difference, such as milliseconds to several seconds, and is also expressed as after Δt seconds) are considered to have little impact, and the amount of computation is reduced by also removing, at time t, sounds that will become inaudible at the estimated position at time t+Δt. In the following example, culling processing will be mainly described as one example of reduction processing, but the reduction processing in the present example may perform at least one of culling processing or integration processing, and is not limited to culling processing.

First, input data (such as a bitstream) is provided to spatial information manager 1501. The input data includes an audio signal or encoded audio data representing an audio signal, and metadata used for acoustic processing. When encoded audio data is included, the encoded audio data is provided to an audio data decoder not shown here, decoding processing is performed, and an audio signal is generated. This audio signal is provided to direct sound generator 1502, reverberant sound generator 1503, reflected sound generator 1504, and diffracted sound generator 1505. If an audio signal is included instead of encoded audio data, the audio signal is directly provided to these sound generators (that is, direct sound generator 1502, reverberant sound generator 1503, reflected sound generator 1504, and diffracted sound generator 1505; the same applies hereinafter when simply referred to as “sound generator(s)” or “generator(s)”).

Spatial information manager 1501 extracts metadata from the input data, and the metadata is provided to direct sound generator 1502, reverberant sound generator 1503, reflected sound generator 1504, and diffracted sound generator 1505. The configuration of the metadata is represented as in FIG. 16. Spatial information 1601 mainly represents information about the space that provides immersive audio to the listener, such as characteristics related to the shape of the room and material properties of walls (sound reflectance, absorptance, etc.), characteristics related to material properties of obstacles (sound reflectance, absorptance, etc.), and information about placement.

Object information 1602 mainly represents information about the position and orientation of the sound source object, and information about sounds emitted from the sound source object.

Listener information 1603 mainly represents information about the position and orientation of the listener.

Direct sound generator 1502, reverberant sound generator 1503, reflected sound generator 1504, and diffracted sound generator 1505 each receive an audio signal and metadata, generate direct sound, reverberant sound, reflected sound, and diffracted sound, respectively, and output them to cullers 1506a to 1506d. The decoder in FIG. 15 is configured with the generators in parallel, and is configured to cull the sounds generated by the respective generators. Here, a configuration is employed in which cullers 1506a to 1506d are disposed downstream of all of the generators, but the configuration is not limited to this, and a configuration may be employed in which a culler is not disposed downstream of some of the generators.

In each of cullers 1506a to 1506d, unimportant sounds are identified with respect to the input signal, the identified sounds are discarded, and the remaining sounds are output to sound generator 1507. Discarding a sound may also be expressed as bypassing or ignoring the sound.

Sound generator 1507 performs acoustic processing such as convolution processing of a head related transfer function (HRTF) on the signals input from each of cullers 1506a to 1506d, and outputs them as output sound signals (also referred to as output signals). This acoustic processing performs processing adapted to the output format for the listener, such as headphones or multi-channel loudspeakers, and provides the output signal to the listener.

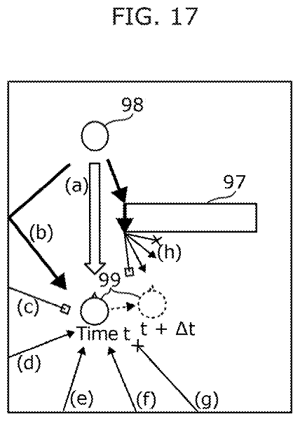

FIG. 17 will be described. FIG. 17 illustrates a conceptual diagram of culling processing in this example. In this figure, an example is illustrated in which the position of sound source object 98 does not move and the position of the listener (user 99) moves.

Direct sound (a), reflected sound (b), reverberant sounds (c) through (g), and diffracted sound (h) reach the position of the listener at time t as illustrated. Among the sounds that reach the listener, sounds with a low importance level according to a certain reference value are culled. In the figure, cross arrows represent sounds that are culled at time t. Note that the reference value here may be the energy of the sound that reaches the listener or the amount of temporal change in the energy, or may utilize the auditory characteristics of the listener. In the following, as one example, a description will be given assuming that the magnitude of the energy of the sound corresponds to the importance level.

Next, the position of the listener Δt seconds later (i.e., at time t+Δt) is predicted. The position of the listener is predicted by storing past positions of the listener in a queue (first-in first-out memory, FIFO), performing prediction based on the position information of the listener stored in the queue, and computationally determining the position of the listener at time t+Δt. As a prediction method, linear prediction may be used, or prediction may be performed by simply extrapolating the most recent position information.

In order to obtain an accurate position of the listener Δt seconds later, a configuration may be employed in which a slight delay is permitted, the input of the next metadata is awaited, and the information of the listener included in that metadata is used. More specifically, when the n-th metadata is denoted as Meta(n), the input of Meta(n+1) is awaited, the position information of the listener included in Meta(n+1) is obtained, and then the processing of Meta(n) is performed. Therefore, although a delay of Δt seconds occurs until the next metadata is input, it becomes possible to obtain an accurate position of the listener Δt seconds later.

Next, the energy of each sound at the position of the listener at time t+Δt is calculated. Among the sounds that reach the listener, sounds with a low importance level according to a certain reference value are culled. In the figure, rectangular arrows represent sounds that are culled at time t+Δt.

The energy of each sound is calculated by prediction from the energy of each sound calculated at the position of the listener at time t, in order to reduce the amount of calculation. The prediction method will be described later.

Note that while the calculation of the energy of sounds that reach the listener at time t+Δt is assumed here, the present disclosure is not limited thereto, and sounds to be culled may be determined based on whether the movement of the listener is abrupt. Stated differently, when the position of the listener at time t and the position of the listener at time t+Δt are significantly separated, the acoustic environment of the listener is considered to have changed significantly, and sounds with a low importance level for the listener (sounds with a low importance level set for the listener, such as reflected sounds, reverberant sounds, and diffracted sounds) are culled. This eliminates the need to calculate sounds that reach the listener at time t+Δt, thereby inhibiting an increase in computational requirements.

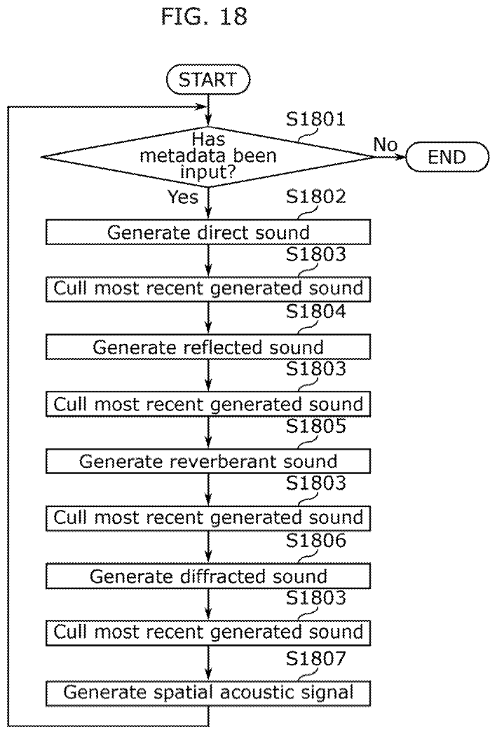

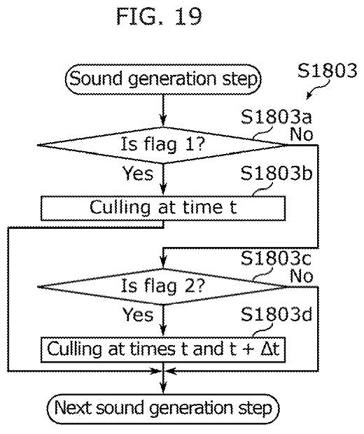

Next, FIG. 18 and FIG. 19 illustrate a flowchart of the operation of the decoder in the above configuration. Note that FIG. 19 illustrates a detailed flow of step S1803 in FIG. 18.

First, whether metadata has been input (whether there is an input of metadata) is determined (S1801). If metadata is input (Yes in S1801), direct sound is generated (S1802), and if metadata is not input (No in S1801), the processing ends.

After direct sound is generated (S1802), whether culling of the most recent generated sound (i.e., the direct sound) is to be performed is determined (S1803). For example, whether the flag is 1 is determined (S1803a), and if the flag is 1 (Yes in S1803a), normal culling based only on time t is performed (S1803b), and the process proceeds to generation of the next sound (i.e., reverberant sound). If the flag is not 1 (No in S1803a), whether the flag is 2 is determined (S1803c), and if the flag is 2 (Yes in S1803c), culling based on both time t and time t+Δt is performed (S1803d), and the process proceeds to generation of the next sound (i.e., reverberant sound). If the flag is not 2 (No in S1803c), the flag is 0, and the process proceeds to generation of the next sound (i.e., reverberant sound) without performing culling.

Note that this flag may always be included in the metadata, or may be preset as a default value. Alternatively, the flag may be preset as a default value, and if the metadata includes an updated value for the flag, the flag may be updated to that value and continue to be used. The flag for each sound generator may be set independently. The same applies to the flags that appear in the subsequent flowcharts.

Next, as illustrated in FIG. 18, reverberant sound is generated (S1804), and, similarly to the above, whether culling of the most recent generated sound (i.e., the reverberant sound) is to be performed is determined (S1803). For the reverberant sound as well, based on the flag value of 0, 1, or 2, similarly to the above, one of the following is performed: culling is not performed, culling that considers only time t is performed, or culling that considers both time t and time t+Δt is performed.

Next, as illustrated in FIG. 18, reflected sound is generated (S1805), and, similarly to the above, whether culling of the most recent generated sound (i.e., the reflected sound) is to be performed is determined (S1803). For the reflected sound as well, based on the flag value of 0, 1, or 2, similarly to the above, one of the following is performed: culling is not performed, culling that considers only time t is performed, or culling that considers both time t and time t+Δt is performed.

Next, as illustrated in FIG. 18, diffracted sound is generated (S1806), and, similarly to the above, whether culling of the most recent generated sound (i.e., the diffracted sound) is to be performed is determined (S1803). For the diffracted sound as well, based on the flag value of 0, 1, or 2, similarly to the above, one of the following is performed: culling is not performed, culling that considers only time t is performed, or culling that considers both time t and time t+Δt is performed.

As a result of the above generation of generated sounds and culling processing, spatial acoustic signal processing such as convolution of HRTF is performed on the remaining direct sound, reverberant sound, reflected sound, and diffracted sound to generate a spatial acoustic signal (S1807), which is output to a device used by the listener such as headphones.

The process returns to step S1801, and whether new metadata is input is determined.

Note that while a method is described here in which one is selected from among three options—a case where culling is not performed, a case where conventional culling based only on time t is performed, and a case where culling based on both time t and time t+Δt, which is a feature of the present example, is performed—the present disclosure is not limited thereto, and a method may be employed in which one is selected from among two options: a case where culling is not performed or a case where culling based on both time t and time t+Δt is performed. In such cases, the flag indicates 0 or 1.

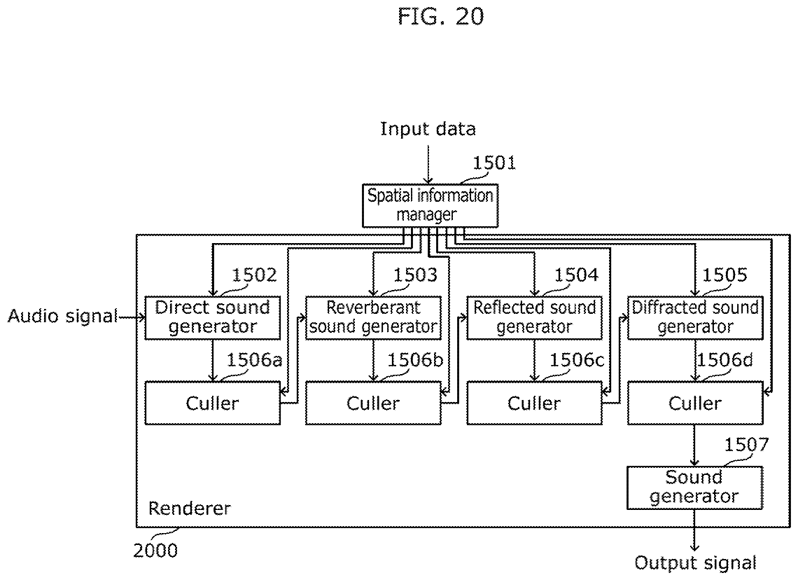

FIG. 20 will be described. FIG. 20 is a block diagram illustrating another configuration of a decoder according to the present example. A characteristic of this configuration is that direct sound generator 1502, reverberant sound generator 1503, reflected sound generator 1504, and diffracted sound generator 1505 are connected in series, and cullers 1506a to 1506d are disposed between the generators. According to this configuration, sound generated by a generator at a preceding stage can affect a generator at the current stage, making it possible to provide accurate immersive audio that is closer to actual spatial acoustics.

Note that while this diagram illustrates a configuration in which cullers 1506a to 1506d are disposed between all of the generators, the configuration is not limited to this, and a configuration may be employed in which some of the cullers is omitted.

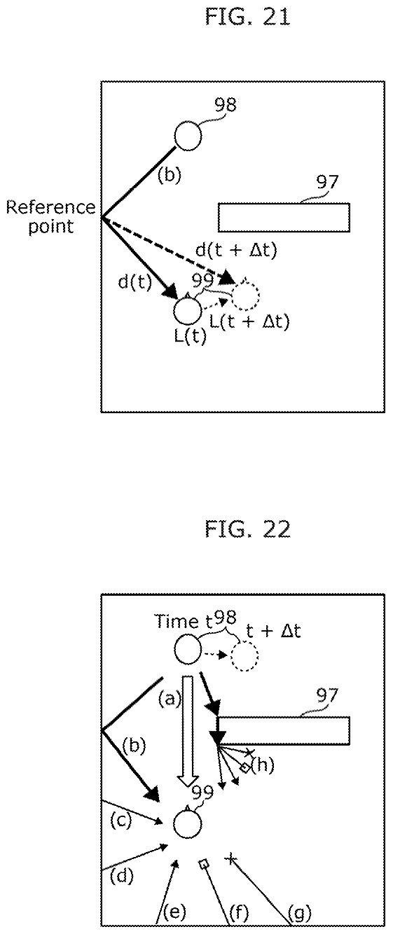

FIG. 21 will be described. FIG. 21 illustrates a diagram similar to FIG. 17. Here, a method for estimating and determining sound at time t+Δt from sound at time t in order to reduce the amount of computation will be described. Note that while the explanation here uses only reflected sound (b) to simplify the explanation, the same applies to direct sound (a), reverberant sounds (c) through (g), and diffracted sound (h).

First, the position of the reference point is calculated from position L(t) of the listener at time t and the position of sound source object 98. Distances d(t) and d(t+Δt) are calculated from the position of the reference point and the position of the listener. Here, d(t) represents the distance between the reference point and the position of the listener at time t. When the energy of sound that the listener hears at time t is expressed as E(t), energy E(t+Δt) of sound at time t+Δt is calculated according to Expression (1) below.

$$\begin{matrix}[ Math . 1 ] & \\ E ( t + Δ t ) = \frac{{‖ d ( t ) ‖}^{2}}{{‖ d ( t + Δ t ) ‖}^{2}} \cdot E ( t ) & ( 1 )\end{matrix}$$

Note that Expression (1) is derived from the relationship that sound pressure is inversely proportional to the square of the distance, but when a different relational expression is assumed, that relational expression is used to derive E(t+Δt). Thereafter, the calculated E(t+Δt) and the loudness threshold are compared. When E(t+Δt) is below the threshold, the reflected sound that is reflected to the listener at time t is culled.

Note that in the case of direct sound, the position of the reference point is not calculated, and the position of sound source object 98 is regarded as the position of the reference point to perform calculation processing similar to the above procedure.

FIG. 22 will be described. FIG. 22 illustrates a diagram similar to FIG. 17. The basic idea in this example is, similar to the above, that sounds that will become inaudible after Δt seconds are considered to have little impact, and the amount of computation is reduced by also culling, at time t, sounds that will become inaudible at the estimated position at time t+Δt.

In the above example, the movement of the listener is predicted to determine the target sound to be culled, whereas a feature of this example is that the movement of sound source object 98 is predicted to determine the target sound to be culled. FIG. 22 illustrates a conceptual diagram of culling processing in this example.

Direct sound (a), reflected sound (b), reverberant sounds (c) through (g), and diffracted sound (h) reach the position of the listener at time t as illustrated. Among the sounds that reach the listener, sounds with a low importance level according to a certain reference value are culled. In the figure, cross arrows represent sounds that are culled at time t.

Next, the position of sound source object 98 Δt seconds later (i.e., at time t+Δt) is predicted. The position of sound source object 98 is predicted by storing past positions of sound source object 98 in a queue, performing prediction based on the position information of sound source object 98 stored in the queue, and determining the position of sound source object 98 at time t+Δt. As a prediction method, linear prediction may be used, or prediction may be performed by simply extrapolating the most recent position information.

In order to obtain an accurate position of sound source object 98 Δt seconds later, a configuration may be employed in which a slight delay is permitted, the input of the next metadata is awaited, and the information of sound source object 98 included in that metadata is used. More specifically, when the n-th metadata is denoted as Meta(n), the input of Meta(n+1) is awaited, the position information of sound source object 98 included in Meta(n+1) is obtained, and then the processing of Meta(n) is performed. Therefore, although a delay occurs until the next metadata is input, it becomes possible to obtain an accurate position of sound source object 98 Δt seconds later.

Next, the energy of each sound at the position of sound source object 98 at time t+Δt is calculated. Among the sounds that reach the listener, sounds with a low importance level according to a certain reference value are culled. In the figure, rectangular arrows represent sounds that are culled at time t+Δt.

The energy of each sound is calculated by prediction from the energy of each sound calculated at the position of the listener at time t, in order to reduce the amount of calculation. The prediction method will be described later.

Note that while the calculation of the energy of sounds that reach the listener at time t+Δt is assumed here, the present disclosure is not limited thereto, and sounds to be culled may be determined based on whether the movement of sound source object 98 is abrupt. Stated differently, when the position of sound source object 98 at time t and the position of sound source object 98 at time t+Δt are significantly far apart, the acoustic environment of the listener is considered to have changed significantly, and sounds with a low importance level for the listener (such as reflected sounds, reverberant sounds, and diffracted sounds) are culled. This eliminates the need to calculate sounds that reach the listener at time t+Δt, thereby inhibiting an increase in computational requirements.

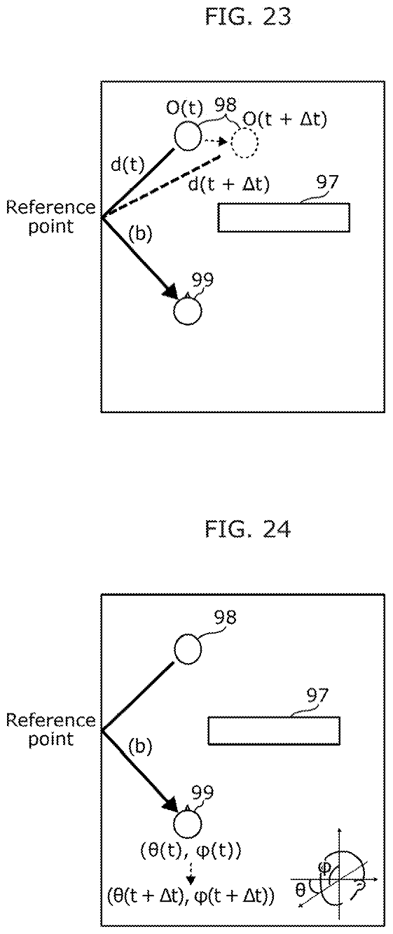

FIG. 23 will be described. FIG. 23 illustrates a diagram similar to FIG. 17. Here, a method for estimating and determining sound at time t+Δt from sound at time t in order to reduce the amount of computation will be described. Note that while the explanation here uses only reflected sound (b) to simplify the explanation, the same applies to direct sound (a), reverberant sounds (c) through (g), and diffracted sound (h).

First, the position of the reference point is calculated from position O(t) of sound source object 98 at time t and the position of the listener. Distances d(t) and d(t+Δt) are calculated from the position of the reference point and the position of sound source object 98. Here, d(t) represents the distance between the position of sound source object 98 and the reference point at time t. Energy E(t+Δt) of sound at time t+Δt is calculated from energy E(t) of sound that the listener hears at time t according to Expression (1) above. Thereafter, the calculated E(t+Δt) and the loudness threshold are compared. When E(t+Δt) is below the threshold, the sound to the listener at time t is culled.

Note that in the case of direct sound, the position of the reference point is not calculated, and the position of the listener is regarded as the position of the reference point to perform calculation processing similar to the above procedure.

FIG. 24 will be described. FIG. 24 illustrates a diagram similar to FIG. 17. A feature of the following example is that the determination of whether to cull the sound reaching the listener is made while also accounting for potential changes in the orientation of the listener's face (azimuth angle: θ, elevation angle: φ) that may occur after Δt seconds. Additionally, the orientation of the listener's face is determined by prediction. Note that while the explanation here uses only reflected sound (b) to simplify the explanation, the same applies to direct sound (a), reverberant sounds (c) through (g), and diffracted sound (h).

The method of predicting the orientation of the listener's face is similar to the prediction of the position of the listener, and may involve storing past orientations of the listener's face in a queue, using linear prediction based on the past orientations of the listener's face stored in the queue, or performing prediction by extrapolating the most recent orientation of the face.

In order to obtain an accurate orientation of the face of the listener Δt seconds later, a configuration may be employed in which a slight delay is permitted, the input of the next metadata is awaited, and the information of the listener included in that metadata is used. More specifically, when the n-th metadata is denoted as Meta(n), the input of Meta(n+1) is awaited, the information on the orientation of the face is obtained from the information of the listener included in Meta(n+1), and then the processing of Meta(n) is performed. Therefore, although a delay occurs until the next metadata is input, it becomes possible to obtain an accurate orientation of the listener's face Δt seconds later. FIG. 24 illustrates a conceptual diagram of culling processing in this example.

When the energy of sound that reaches the listener when the orientation of the listener's face at time t is (0 (t), @ (t)) is expressed as E(t), energy E(t+Δt) of sound that reaches the listener when the orientation of the listener's face at time t+Δt is (0 (t+Δt), P(t+Δt)) is calculated according to Expression (2) below.

$$\begin{matrix}[ Math . 2 ] & \\ e ( t + Δ t ) = E ( t ) \cdot cos ( θ ( t ) - θ ( t + Δ t ) ) \cdot cos ( φ ( t ) - φ ( t + Δ t ) ) & ( 2 )\end{matrix}$$

This energy estimated value E(t+Δt) at time t+Δt is compared with the loudness threshold, and when E(t+Δt) is below the threshold, the reflected sound to the listener at time t is culled.

Note that while the calculation of the energy of sounds that reach the listener at time t+Δt is assumed here, the present disclosure is not limited thereto, and sounds to be culled may be determined based on whether the movement of the orientation of the listener's face is abrupt. Stated differently, when the orientation of the listener's face at time t and the orientation of the listener's face at time t+Δt change significantly, the acoustic environment of the listener is considered to have changed significantly, and sounds with a low importance level for the listener (such as reflected sounds, reverberant sounds, and diffracted sounds) are culled. This eliminates the need to calculate sounds that reach the listener at time t+Δt, thereby inhibiting an increase in computational requirements.

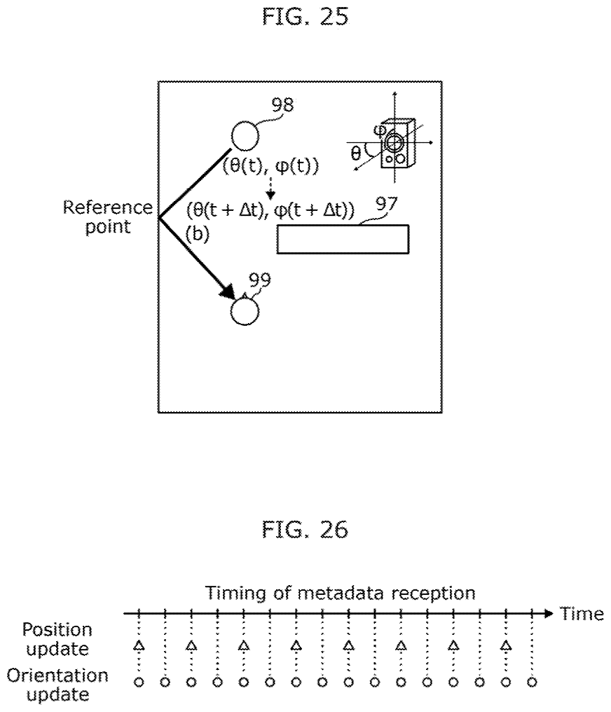

FIG. 25 will be described. FIG. 25 illustrates a diagram similar to FIG. 17. The following example illustrates another implementation of the example described in FIG. 24. A feature here is that the determination of whether to cull the sound is made while also accounting for potential changes in the orientation of sound source object 98 (azimuth angle: θ, elevation angle: φ) that may occur after Δt seconds. Note that while the explanation here uses only reflected sound (b) to simplify the explanation, the same applies to direct sound (a), reverberant sounds (c) through (g), and diffracted sound (h).

The orientation of sound source object 98 is determined by prediction, and the method of predicting the orientation of sound source object 98 is similar to the prediction of the position of sound source object 98, and may involve storing past orientations of sound source object 98 in a queue, using linear prediction based on the past orientations of sound source object 98 stored in the queue, or performing prediction by extrapolating the most recent orientation of sound source object 98.

In order to obtain an accurate orientation of sound source object 98 Δt seconds later, a configuration may be employed in which a slight delay is permitted, the input of the next metadata is awaited, and the information of sound source object 98 included in that metadata is used. More specifically, when the n-th metadata is denoted as Meta(n), the input of Meta(n+1) is awaited, the orientation information of sound source object 98 is obtained from the information of sound source object 98 included in Meta(n+1), and then the processing of Meta(n) is performed. Therefore, although a delay occurs until the next metadata is input, it becomes possible to obtain an accurate orientation of sound source object 98 Δt seconds later. FIG. 25 illustrates a conceptual diagram of culling processing in this example.

When the energy of sound that reaches the listener when the orientation of sound source object 98 at time t is (θ(t), φ(t)) is expressed as E(t), energy E(t+Δt) of sound that reaches the listener when the orientation of sound source object 98 at time t+Δt is (θ(t+Δt), φ(t+Δt)) is calculated according to Expression (2) above.

This energy estimated value E(t+Δt) at time t+Δt is compared with the loudness threshold, and when E(t+Δt) is below the threshold, the reflected sound to the listener at time t is culled.

Note that while the calculation of the energy of sounds that reach the listener at time t+Δt is assumed here, the present disclosure is not limited thereto, and sounds to be culled may be determined based on whether the orientation of sound source object 98 is abrupt. Stated differently, when the orientation of sound source object 98 at time t and the orientation of sound source object 98 at time t+Δt change significantly, the acoustic environment of the listener is considered to have changed significantly, and sounds with a low importance level for the listener (such as reflected sounds, reverberant sounds, and diffracted sounds) are culled. This eliminates the need to calculate sounds that reach the listener at time t+Δt, thereby inhibiting an increase in computational requirements.

FIG. 26 will be described. A feature of this example is that, with respect to changes in position and changes in orientation of the listener or sound source object 98, the changes in position and the changes in orientation are estimated at different temporal resolutions (note that the time interval for updating position and the time interval for updating orientation being different is referred to here as different temporal resolutions). This is based on the idea that since changes in orientation tend to occur more frequently than changes in position, reflecting changes in orientation more frequently improves culling performance.

Note that depending on the application, there are also cases where changes in position occur more frequently than changes in orientation. In such cases, culling performance may also be improved by setting the temporal resolution of changes in position higher than the temporal resolution of changes in orientation.

FIG. 26 illustrates a conceptual diagram illustrating the timing of metadata obtainment according to the present example. The horizontal axis represents time, timing of receiving metadata is represented by vertical lines, and the queue is updated each time metadata is received. Timing of estimating position (culling based on position information) is represented by open triangles, and timing of estimating orientation (culling based on orientation information) is represented by open circles. This figure illustrates that estimation of changes in orientation is performed at a higher temporal resolution than estimation of changes in position.

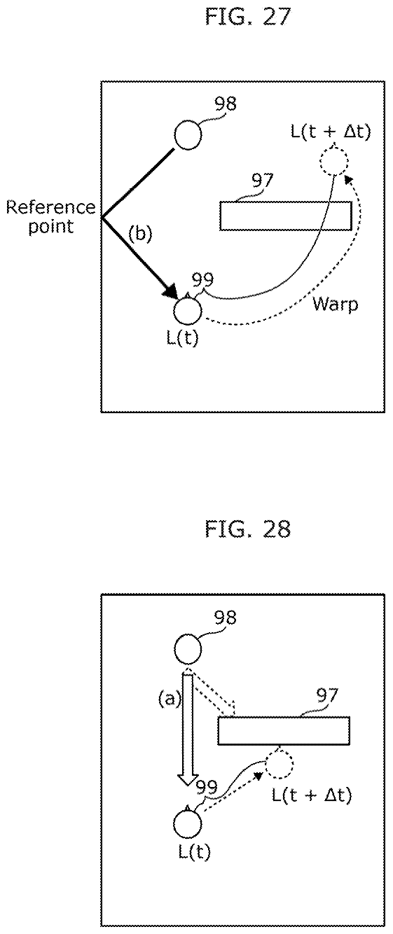

FIG. 27 will be described. FIG. 27 illustrates a diagram similar to FIG. 17. One feature is that when the movement of the listener or sound source object 98 is discontinuous, culling based on movement prediction as described above is stopped. This means that when the movement is discontinuous, the environment surrounding the listener at time t and the environment surrounding the listener at time t+Δt differ significantly. Therefore, performing culling at time t using information from time t+Δt may result in removing, through culling, sounds that are originally necessary, which can lead to providing unnatural immersive audio to the listener. Therefore, by adopting the approach of the present example, such issues can be avoided.

Note that the sound here may be any of direct sound, reflected sound, reverberant sound, or diffracted sound.

Depending on the application, the movement of the listener or sound source object 98 may become discontinuous. (For example, in a game using immersive audio, warping to a different location after clearing a certain event, etc.). In such cases, execution of culling based on predicted movement is stopped.

FIG. 27 illustrates a conceptual diagram of discontinuous movement assumed in this example. When position L(t) of the listener at time t and position L(t+Δt) of listener Δt seconds later are significantly separated, the environment of the listener changes significantly, and therefore if culling at time t that takes into account time t+Δt is performed, even necessary sounds may be culled, potentially causing inconveniences such as inducing degradation of acoustic effects. In this way, when the movement of the user is discontinuous, culling based on movement prediction is stopped to avoid occurrence of the above-described problem.

Note that one method for determining whether the movement of the listener is discontinuous is to determine that the movement is discontinuous when the amount of movement of the listener exceeds a predetermined threshold. When the metadata includes a flag indicating that the movement of the listener is discontinuous, whether the movement of the listener is discontinuous can be determined by referring to that flag.

Note that while the movement of the listener has been used as an example in the description here, the present disclosure is not limited thereto, and the same applies when the movement of sound source object 98 is discontinuous.

FIG. 28 will be described. FIG. 28 illustrates a diagram similar to FIG. 17. In the present example, one feature is that when the listener or sound source object 98 moves and obstacle 97 appears on the sound path between sound source object 98 and the listener, culling processing based on movement prediction is stopped. This means that when obstacle 97 appears on the sound path at time t+Δt, the environment surrounding the listener at time t and the environment surrounding the listener at time t+Δt differ significantly. Therefore, performing culling at time t using information from time t+Δt may result in removing, through culling, sounds that are originally necessary, which can lead to providing unnatural immersive audio to the listener. Therefore, by adopting the approach of the present example, such issues can be avoided.

Note that the sound here may be any of direct sound, reflected sound, reverberant sound, or diffracted sound.

FIG. 28 illustrates a conceptual diagram of the occurrence of an obstacle assumed in this example. FIG. 28 illustrates a case where obstacle 97 occurs on the path of direct sound (a) due to the listener moving. In this way, because the environment surrounding the listener changes significantly due to the listener's movement, culling processing based on movement prediction is stopped. Whether or not obstacle 97 occurs on the path of such sound can be determined from the information itself included in the metadata, or by analyzing that information.

Note that while the movement of the listener has been used as an example in the description here, the present disclosure is not limited thereto, and the same applies when sound source object 98 moves.

Whether the movement of the listener or sound source object 98 is high-speed may be determined, and when the movement is determined to be high-speed, culling processing based on movement prediction may be similarly stopped. When the movement of the listener or sound source object 98 is high-speed, the possibility that obstacle 97 will appear between sound source object 98 and the listener increases. Therefore, by stopping culling processing based on movement prediction, it is possible to avoid providing unnatural immersive audio to the listener, similarly to the above.

The above description can be regarded as a simplified version of an example of detecting the occurrence of obstacle 97, and instead of determining whether obstacle 97 appears on the path of sound, determination is performed based on the speed of movement of the listener or sound source object 98.

The speed of movement of the listener or sound source object 98 can be determined by storing past positions of the listener and sound source object 98 in a queue, and using the position information of the listener or sound source object 98 stored in the queue.

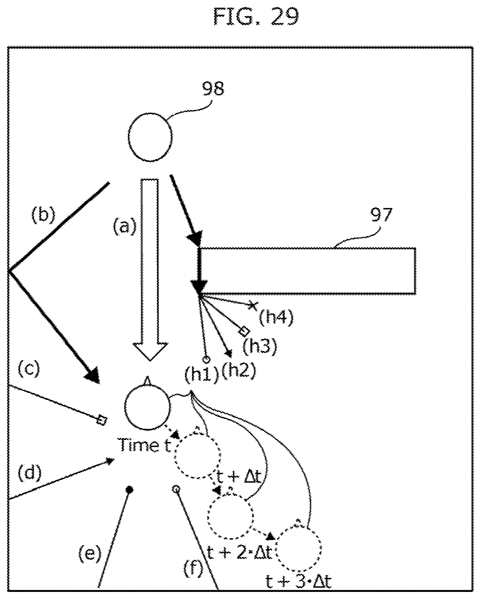

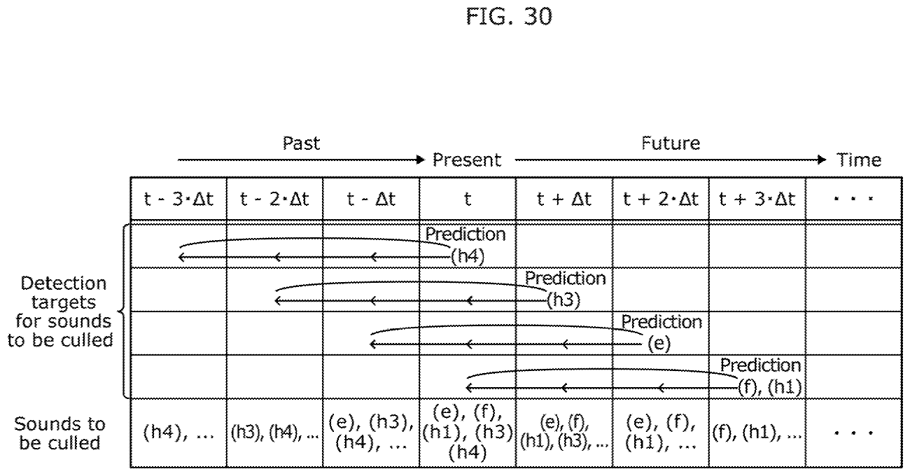

FIG. 29 and FIG. 30 will be described. FIG. 29 illustrates a diagram similar to FIG. 17. In the above-described example, a feature was that the movement of the listener Δt seconds later is predicted for the listener at the position at time t, and culling of sounds reaching the listener at the position at time t+Δt is also performed together with culling of sounds reaching the listener at the position at time t. In contrast, in the present example, a feature is that the movement of the listener n×Δt seconds later (n is an integer greater than or equal to 2) is predicted for the listener at the position at time t, and culling of sounds reaching the listener at positions from time t+Δt to time t+n·Δt is also performed together with culling of sounds reaching the listener at the position at time t. In the present example, the position of the listener at a time further ahead than the already-described example is estimated, and sounds with low influence among sounds reaching the listener up to that time further ahead are subject to culling. This further increases the number of sounds subject to culling, making it possible to achieve a more pronounced effect of reducing computational requirements.

FIG. 29 and FIG. 30 illustrate a conceptual diagram of culling processing in this example. In this figure, an example is illustrated in which the position of sound source object 98 does not move and the position of the listener moves.

Direct sound (a), reflected sound (b), reverberant sounds (c) through (f), and diffracted sounds (h1) through (h4) reach the position of the listener at time t as illustrated. Among the sounds that reach the listener, sounds with a low importance level according to a certain reference value are culled. In the figure, cross arrows represent sounds that are culled at time t, rectangular arrows represent sounds that are culled at time t+Δt, black circle arrows represent sounds that are culled at time t+2·Δt, and white circle arrows represent sounds that are culled at time t+3·Δt, respectively. Note that the reference value here may be the energy of the sound that reaches the listener or the amount of temporal change in the energy, or may utilize the auditory characteristics of the listener. Note that the position of the listener at each time is obtained by prediction using the method as already described.

In the figure, an example is illustrated in which diffracted sound (h4) is identified as a sound to be culled at time t, diffracted sound (h3) is identified as a sound to be culled at time t+Δt, reverberant sound (e) is identified as a sound to be culled at time t+2·Δt, and reverberant sound (f) and diffracted sound (h1) are identified as sounds to be culled at time t+3·Δt.

FIG. 30 illustrates up to which time these sounds to be culled have an effect. As illustrated in FIG. 30, a sound identified as being culled at a certain time is culled retroactively to a predetermined past time, thereby achieving efficient reduction in computational load. This point is a feature of the present example.

In the above example, a case where the listener moves has been described, but the present disclosure is not limited thereto, and the same applies to a case where sound source object 98 moves.

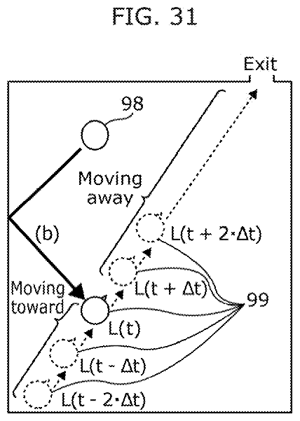

FIG. 31 will be described. FIG. 31 illustrates a diagram similar to FIG. 17. In the above-described example, the movement of the listener Δt seconds later is predicted for the listener at the position at time t, and the position of the listener at time t+Δt is also used for culling at time t. In contrast, in the present example, a feature is that a determination is made as to whether the movement of the listener is in a direction approaching the sound reaching the listener or in a direction moving away from the sound, and culling is performed according to the determination result. Assuming that the movement of the listener is in a direction moving away from the sound reaching the listener, and the reference value of the sound is compared with a predetermined threshold and falls below the threshold, the sound at time t+Δt and thereafter is always culled. This is an effective method in scenes where the movement of the listener is oriented in a substantially constant direction. Note that the reference value here may be the energy of the sound that reaches the listener or the amount of temporal change in the energy, or may utilize the auditory characteristics of the listener.

FIG. 31 illustrates a conceptual diagram of listener movement assumed in this example. In this figure, a scene is illustrated in which the listener is moving toward the exit in the upper right. It is illustrated that until time t, the movement is in a direction moving toward reflected sound (b), and from time t+Δt onward, the movement is in a direction moving away from reflected sound (b). Note that while reflected sound (b) is used as an example in the explanation here, the present disclosure is not limited thereto, and the same can be applied to direct sound (a), reverberant sounds (c) through (g), diffracted sound (h), and the like.

Until time t, culling of reflected sound (b) is not performed because the movement is in a direction moving toward reflected sound (b). However, from time t+Δt onward, the movement is in a direction moving away from reflected sound (b). Therefore, from time t+Δt onward, reflected sound (b) becomes a candidate for culling. When reflected sound (b) becomes a candidate for culling, a reference value is compared with a predetermined threshold in reflected sound (b), and when the reference value is below the predetermined threshold, reflected sound (b) is culled. Since the listener is moving in a direction moving away from reflected sound (b), once it is determined that reflected sound (b) is to be culled, culling of reflected sound (b) is automatically continued thereafter.

In the above example, a case where the listener moves has been described, but the present disclosure is not limited thereto, and the same applies to a case where sound source object 98 moves.

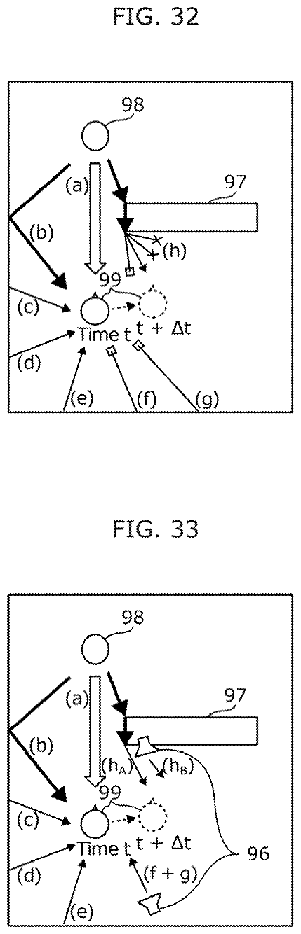

FIG. 32 and FIG. 33 will be described. FIG. 32 and FIG. 33 illustrate diagrams similar to FIG. 17. As illustrated in FIG. 32, in the above-described example, the movement of the listener Δt seconds later is predicted for the listener at the position at time t, and culling of sounds reaching the listener at the position at time t+Δt is also performed together with culling of sounds reaching the listener at the position at time t. In contrast, in this example, instead of culling, a plurality of sounds to be culled are collectively regarded as sounds output from virtual object 96. This makes it possible to substitute a plurality of sounds to be culled with sounds output from a smaller number of virtual objects 96, enabling reduction of the amount of computation. In addition, since a plurality of sounds to be culled are not completely discarded, degradation of immersive audio due to culling can be avoided to a certain extent.

FIG. 33 illustrates a conceptual diagram of integration processing in this example. In this figure, a case where reverberant sounds (f) and (g), and a portion of diffracted sound (h) are selected as sounds to be integrated is illustrated. As illustrated in this figure, by the integration processing, sounds to be integrated are collectively integrated into sounds output from a smaller number of virtual objects 96 (virtual sound of reverberant sound (f+g) and virtual sound of diffracted sound (h_{B}), where virtual sound (h_{A}) indicates remaining diffracted sound that was not integrated) and are output from virtual objects 96.

Although an example has been described here in which a combination of reverberant sounds and a combination of diffracted sounds are each integrated into virtual objects 96, the present disclosure is not limited thereto, and sounds of different properties, such as a combination of reverberant sound and diffracted sound, may be integrated into a single virtual object 96 and output.

As a method for collectively integrating a plurality of sounds to be integrated, for example, a method may be used in which sounds to be integrated are added and are regarded as sounds output from virtual object 96. During addition, at least one of the energy or phase of each sound may be adjusted before addition.

While examples have been described above, the present disclosure is not limited to the above examples, and for example, the following processing may be performed as processing when prediction is incorrect.

When a difference between an estimated value and an actual value of the position or orientation of the listener or sound source object 98 after Δt exceeds a predetermined threshold, this may be regarded as incorrect prediction, and processing for when prediction is incorrect may be performed. Here, the actual value can be obtained from the information of sound source object 98 included in that metadata by permitting a slight delay and awaiting the input of the next metadata. As processing for when prediction is incorrect, processing using prediction, that is, culling processing for sounds reaching the listener in the state at time t+Δt, is stopped.

Although sounds reaching the listener have been described here using direct sound, reflected sound, reverberant sound, and diffracted sound, the above processing may be applied only to direct sound and reflected sound, which have relatively large energy.

Although the subject matter of the examples has been described thus far based on sound propagation, the present disclosure is not limited to sound propagation and the same processing can also be applied to, for example, light propagation.

Regarding light propagation, the processing is applicable to computer graphics that generate scenes based on direct light, reflected light, and diffracted light. More specifically, culling of light reaching the user at time t is performed using light (direct light, reflected light, diffracted light) reaching the user from the light source at the estimated position of the user at time t+Δt in a virtual space or a space that fuses a virtual space and real space. This enables stopping generation of only light with low priority, so the degree of degradation in the quality of computer graphics provided to the user can be kept small, and the amount of computation for generating computer graphics can be greatly reduced.

### Other Embodiments

While exemplary embodiments have been described above, the present disclosure is not limited to the above-described embodiments.

For example, the acoustic reproduction system described in the above embodiments may be implemented as a single device including all elements, or may be implemented by a plurality of devices, with each function allocated to the devices and these devices cooperating with each other. In the latter case, an information processing device such as a smartphone, tablet terminal, or personal computer (PC) may be used as a device corresponding to the information processing device. For example, in acoustic reproduction system 100 having a function as a renderer that generates an acoustic signal added with an acoustic effect, a server may handle all or part of the functions of the renderer. Stated differently, all or part of obtainer 111, route calculator 121, output sound generator 131, and signal outputter 141 may be implemented in a server not shown in the figure. In such case, acoustic reproduction system 100 is implemented by combining an information processing device such as a computer or smartphone, an audio presentation device such as a head-mounted display (HMD) or earphones worn by user 99, and a server not illustrated in the figures. Note that the computer, audio presentation device, and server may be communicably connected on the same network or may be connected on different networks. When connected on different networks, the possibility of communication delays increases, so a configuration may be adopted in which processing on the server is permitted only when the computer, audio presentation device, and server are communicably connected on the same network. Based on the amount of data in the bitstream received by acoustic reproduction system 100, a configuration in which whether or not all or part of the renderer's functions are to be handled by the server is determined may be implemented.

The acoustic reproduction system according to the present disclosure can also be implemented as an information processing device that is connected to a reproduction device including only drivers, and that only reproduces output sound signals generated based on obtained sound information for the reproduction device. In such cases, the information processing device may be implemented as hardware including dedicated circuits, or may be implemented as software for causing a general-purpose processor to execute specific processing.

In the above embodiments, processing executed by a specific processor may be executed by another processor. The order of a plurality of processes may be changed, and a plurality of processes may be executed in parallel.

Moreover, in the above embodiments, each element may be realized by executing a software program suitable for the element. Each of the elements may be realized by means of a program executing unit, such as a central processing unit (CPU) or a processor, reading and executing the software program recorded on a recording medium such as a hard disk or a semiconductor memory.

Each of the structural elements may be implemented by hardware. For example, each element may be a circuit (or an integrated circuit). These circuits may constitute one circuit as a whole, or may be separate circuits. These circuits may each be a general-purpose circuit or a dedicated circuit.

General or specific aspects of the present disclosure may be realized as a device, a method, an integrated circuit, a computer program, or a computer-readable recording medium such as a CD-ROM. General or specific aspects of the present disclosure may be realized as any given combination of a device, an apparatus, a method, an integrated circuit, a computer program, and a recording medium.

For example, the present disclosure may be implemented as an audio signal reproduction method executed by a computer, or may be implemented as a program for causing a computer to execute an audio signal reproduction method. The present disclosure may be implemented as a computer-readable non-transitory recording medium having the program recorded thereon.

Embodiments arrived at by a person skilled in the art making various modifications to any one of the embodiments, or embodiments realized by arbitrarily combining elements and functions in the embodiments which do not depart from the essence of the present disclosure are also included in the present disclosure.

Note that the encoded sound information in the present disclosure can be rephrased as a bitstream including a sound signal, which is information about a predetermined sound reproduced by acoustic reproduction system 100, and metadata, which is information about a localization position when localizing the sound image of the predetermined sound at a predetermined position in a three-dimensional sound field. For example, the sound information may be obtained by acoustic reproduction system 100 as a bitstream encoded in a predetermined format such as MPEG-H 3D Audio (ISO/IEC 23008-3). As one example, the encoded sound signal includes information about a predetermined sound that is reproduced by acoustic reproduction system 100. Here, the predetermined sound is a sound emitted by a sound source object existing in the three-dimensional sound field or an environmental sound, and can include, for example, mechanical sounds, or voices of animals including humans. Note that when there are a plurality of sound source objects in the three-dimensional sound field, acoustic reproduction system 100 obtains a plurality of sound signals respectively corresponding to the plurality of sound source objects.

Metadata is, for example, information used for controlling acoustic processing on the sound signal in acoustic reproduction system 100. The metadata may be information used for describing a scene expressed in the virtual space (three-dimensional sound field). Here, the term “scene” refers to an aggregate of all elements representing three-dimensional images and acoustic events in the virtual space, which are modeled in acoustic reproduction system 100 using metadata. Thus, metadata herein may include not only information for controlling acoustic processing, but also information for controlling video processing. The metadata may of course include information for controlling only acoustic processing or video processing, or may include information for use in controlling both. In the present disclosure, the bitstream obtained by acoustic reproduction system 100 may include such metadata. Alternatively, acoustic reproduction system 100 may obtain metadata separately from the bitstream, as described later.

Acoustic reproduction system 100 generates virtual acoustic effects by performing acoustic processing on the sound signal using metadata included in the bitstream and additionally obtained interactive position information of user 99. For example, acoustic effects such as early reflected sound generation, late reverberant sound generation, diffracted sound generation, distance attenuation effect, localization, sound image localization processing, or Doppler effect may be added. Information for switching on or off all or part of the acoustic effects may be added as metadata.

Note that the entire metadata or part of the metadata may be obtained from somewhere other than a bitstream that includes sound information. For example, metadata for controlling an acoustic sound or metadata for controlling a video may be obtained from somewhere other than from a bitstream or both may be obtained from somewhere other than from a bitstream.

When metadata for controlling video is included in the bitstream obtained by acoustic reproduction system 100, acoustic reproduction system 100 may include a function to output metadata that can be used for controlling video to a display device that displays images, or to a stereoscopic image reproduction device that reproduces stereoscopic images.

As an example, encoded metadata includes information about a three-dimensional sound field including a sound source object that emits sound and an obstacle object and information about a localization position when the sound image of the sound is localized at a predetermined position in the three-dimensional sound field (i.e., the sound is perceived as arriving from a predetermined direction), namely, information about the predetermined direction. Here, an obstacle object is an object that can affect the sound perceived by user 99, for example, by blocking or reflecting the sound, during the period until the sound emitted by the sound source object reaches user 99. Obstacle objects can include not only stationary objects but also animals such as humans or mobile bodies such as machines. When there are a plurality of sound source objects in the three-dimensional sound field, for any given sound source object, the other sound source objects can become obstacle objects.

Non-emitting sound source objects such as building material and inanimate objects and sound emitting sound source objects can both be obstacle objects.

The metadata may include, as spatial information including the metadata, not only the shape of the three-dimensional sound field, but also information representing the shape and position of obstacle objects existing in the three-dimensional sound field, and the shape and position of sound source objects existing in the three-dimensional sound field. The three-dimensional sound field may be either a closed space or an open space, and the metadata includes, for example, information representing the reflectivity of structures that can reflect sound in the three-dimensional sound field, such as floors, walls, or ceilings, and the reflectivity of obstacle objects present in the three-dimensional sound field. As used herein, reflectance is the ratio of energy of reflected sound to incident sound, and is set for each frequency band of the sound. The reflectance may be set uniformly regardless of the frequency band of the sound. If the three-dimensional sound field is an open space, parameters such as a uniformly set attenuation rate, diffracted sound, or early reflected sound may be used.

In the above description, reflectance is stated as a parameter with regard to an obstacle object or a sound source object included in metadata, but the metadata may include information other than reflectance. For example, information on the material of an object may be included as metadata related to both of a sound source object and a non-emitting sound source object. Specifically, metadata may include a parameter such as a diffusion factor, a transmittance, or an acoustic absorptivity.

Information related to the sound source object may include loudness, radiation characteristics (directivity), reproduction conditions, the number and types of sound sources emitted from a single object, or information specifying the sound source region in the object. The reproduction condition may determine that a sound is, for example, a sound that is continuously being emitted or is emitted at an event. The sound source region in the object may be determined based on the relative relationship between the position of user 99 and the position of the object, or may be determined with reference to the object. When determined based on the relative relationship between the position of user 99 and the position of the object, with respect to the plane along which user 99 is looking at the object, user 99 can be made to perceive that sound X is emitted from the right side of the object and sound Y is emitted from the left side of the object as seen from user 99. When determined with reference to the object, regardless of the direction in which user 99 is looking, it is possible to fixate which sound is emitted from which region of the object. For example, user 99 can be made to perceive that a high-pitched sound is emitted from the right side and a low-pitched sound is emitted from the left side when viewing the object from the front. In this case, when user 99 moves around to the back of the object, user 99 can be made to perceive that a low-pitched sound is emitted from the right side and a high-pitched sound is emitted from the left side as seen from the back.

The time until an initial reflected sound arrives, the reverberation time, or the ratio between the direct sound and the diffused sound, for instance, can be included as metadata related to a space. When the ratio between the direct sound and the diffused sound is zero, user 99 can be made to perceive only the direct sound.

Information indicating the position and orientation of user 99 in the three-dimensional sound field may be included in the bitstream as metadata as an initial setting, or may not be included in the bitstream. When information indicating the position and orientation of user 99 is not included in the bitstream, information indicating the position and orientation of user 99 is obtained from information other than the bitstream. For example, regarding position information of user 99 in a VR space, the position information may be obtained from an application providing VR content. Regarding position information of user 99 for presenting sound as AR, position information obtained by performing self-position estimation using GPS, a camera, or Laser Imaging Detection and Ranging (LIDAR) on the mobile terminal, for example, may be used. Note that the sound signal and metadata may be stored in a single bitstream or may be separately stored in a plurality of bitstreams. Similarly, the sound signal and metadata may be stored in a single file or may be separately stored in a plurality of files.

When the sound signal and metadata are separately stored in a plurality of bitstreams, information indicating other relevant bitstreams may be included in one or some of the plurality of bitstreams in which the sound signal and metadata are stored. Information indicating other relevant bitstreams may be included in the metadata or control information of each bitstream of the plurality of bitstreams in which the sound signal and metadata are stored. When the sound signal and metadata are separately stored in a plurality of files, information indicating other relevant bitstreams or files may be included in one or some of the plurality of files in which the sound signal and metadata are stored. Information indicating other relevant bitstreams or files may be included in the metadata or control information of each bitstream of the plurality of bitstreams in which the sound signal and metadata are stored.

Here, the related bitstream or the related file is a bitstream or a file that may be simultaneously used in acoustic processing, for example. Information indicating other relevant bitstreams may be collectively described in the metadata or control information of one bitstream of the plurality of bitstreams in which the sound signal and metadata are stored, or may be separately described in the metadata or control information of two or more bitstreams of the plurality of bitstreams in which the sound signal and metadata are stored. Similarly, information indicating other relevant bitstreams or files may be collectively described in the metadata or control information of one file of the plurality of files in which the sound signal and metadata are stored, or may be separately described in the metadata or control information of two or more files of the plurality of files in which the sound signal and metadata are stored. A control file that collectively describes information indicating other relevant bitstreams or files may be generated separately from the plurality of files in which the sound signal and metadata are stored. In such cases, the control file need not store the sound signal and metadata.

Here, information indicating a relevant other bitstream or file may be an identifier indicating the other bitstream, a file name showing the other file, a uniform resource locator (URL), or a uniform resource identifier (URI), for instance. In this case, the obtainer identifies or obtains a bitstream or a file, based on information indicating a relevant other bitstream or file. Information indicating other relevant bitstreams may be included in the metadata or control information of at least some of the plurality of bitstreams in which the sound signal and metadata are stored, and information indicating other relevant files may be included in the metadata or control information of at least some of the plurality of files in which the sound signal and metadata are stored. Here, a file that includes information indicating a relevant bitstream or file may be a control file such as a manifest file for use in distributing content, for example.

### INDUSTRIAL APPLICABILITY

The present disclosure is useful for acoustic reproduction, such as making a user perceive three-dimensional sound.

1. An acoustic processing device comprising:
an obtainer that obtains sound information including: an acoustic signal; and information on a state of a sound source object in a three-dimensional sound field;
a relative relationship calculator that calculates a first relative relationship that is a relative relationship of the state between the sound source object and a user in the three-dimensional sound field at a predetermined time point, and a second relative relationship that is a relative relationship of the state between the sound source object and the user in the three-dimensional sound field at a subsequent time point after the predetermined time point; and
a reduction processor that generates an output sound signal excluding a signal of a sound, the output sound signal being generated by removing, according to the first relative relationship and the second relative relationship, the signal from among signals of a plurality of sounds generated for use in generating the output sound signal from the acoustic signal included in the sound information obtained.

2. The acoustic processing device according to claim 1, wherein
the state is a position in the three-dimensional sound field.

3. The acoustic processing device according to claim 1, wherein
the state is an orientation in the three-dimensional sound field determined by at least one of an azimuth angle or an elevation angle.

4. The acoustic processing device according to claim 1, wherein
the state includes a position in the three-dimensional sound field and an orientation in the three-dimensional sound field determined by at least one of an azimuth angle or an elevation angle, and the first relative relationship and the second relative relationship when the state is the position in the three-dimensional sound field and the first relative relationship and the second relative relationship when the state is the orientation in the three-dimensional sound field have respectively different time intervals between the predetermined time point and the subsequent time point.

5. The acoustic processing device according to claim 1, wherein
the state is at least one of a position in the three-dimensional sound field or an orientation in the three-dimensional sound field determined by at least one of an azimuth angle or an elevation angle, and
the reduction processor removes the signal according to whether a temporal change in a relative relationship indicated by the second relative relationship with respect to the first relative relationship indicates movement in a direction in which the sound source object and the user move away from each other.

6. The acoustic processing device according to claim 1, wherein
the reduction processor removes the signal from among the signals of the plurality of sounds according to the first relative relationship, the second relative relationship, and an importance level set for each sound with respect to the user.

7. The acoustic processing device according to claim 1, wherein
the reduction processor removes the signal from among the signals of the plurality of sounds according to the first relative relationship, the second relative relationship, and an importance level set for each sound with respect to the user when a difference between the first relative relationship and the second relative relationship exceeds a predetermined threshold.

8. The acoustic processing device according to claim 1, wherein
the reduction processor includes a culler that removes a signal of a sound by discarding the signal of the sound.

9. The acoustic processing device according to claim 1, wherein
the reduction processor includes an integrator that removes signals of at least two sounds by discarding the signals of the at least two sounds and supplementing one signal of a virtual sound that integrates the signals of the at least two sounds.

10. The acoustic processing device according to claim 1, wherein
the reduction processor prohibits removal of a signal of a sound according to the second relative relationship when a change in the state of at least one of the sound source object or the user between the predetermined time point and the subsequent time point satisfies a predetermined condition.

11. The acoustic processing device according to claim 10, wherein
the predetermined condition is that the change in the state of at least one of the sound source object or the user between the predetermined time point and the subsequent time point is discontinuous.

12. The acoustic processing device according to claim 10, wherein
the predetermined condition is that a speed of the change in the state of at least one of the sound source object or the user between the predetermined time point and the subsequent time point exceeds a predetermined speed.

13. The acoustic processing device according to claim 10, wherein
the predetermined condition is that an occurrence of an obstacle between the sound source object and the user is indicated.

14. The acoustic processing device according to claim 10, wherein
the predetermined condition is that a deviation between a calculation result of the state of at least one of the sound source object or the user at the subsequent time point and an actual measurement value exceeds a predetermined threshold.

15. An acoustic processing method executed by a computer, the acoustic processing method comprising:
obtaining sound information including: an acoustic signal; and information on a state of a sound d source object in a three-dimensional sound field;
calculating a first relative relationship that is a relative relationship of the state between the sound source object and a user in the three-dimensional sound field at a predetermined time point, and a second relative relationship that is a relative relationship of the state between the sound source object and the user in the three-dimensional sound field at a subsequent time point after the predetermined time point; and
generating an output sound signal excluding a signal of a sound, the output sound signal being generated by removing, according to the first relative relationship and the second relative relationship, the signal from among signals of a plurality of sounds generated for use in generating the output sound signal from the acoustic signal included in the sound information obtained.

16. A non-transitory computer-readable recording medium for use in a computer, the recording medium having a computer program recorded thereon for causing the computer to execute the acoustic processing method according to claim 15.
